(19) United States
(12) Patent Application Publication
(10) Pub. No.: US 2026/0205226 A1
(43) Pub. Date: Jul. 16, 2026

(54) APPROXIMATION IN PROBABILISTIC CONSTELLATION SHAPING

(71) Applicant: QUALCOMM Incorporated, San Diego, CA (US)

(72) Inventors: Wei LIU, Beijing (CN); Thomas Joseph RICHARDSON, South Orange, NJ (US); Hao XU, Beijing (CN)

(21) Appl. No.: 19/130,502

(22) PCT Filed: Jan. 12, 2023
(86) PCT No.: PCT/CN2023/071842

§ 371 Date: May 15, 2025

(51) Int. Cl. H04L 1/00

(52) U.S. Cl. CPC H04L 1/0042

(57) ABSTRACT

Methods, systems, and devices for wireless communications are described. A wireless device may implement probabilistic constellation shaping (PCS) to encode a set of information bits to a symbol sequence based on an approximation of a logarithm of a cumulative sequence quantity. During a shaping procedure, the device may approximate the logarithm of the cumulative sequence quantity based on a normalized energy value, a saturated entropy function of the normalized energy value, a first sequence length, a first sequence energy, and a first symbol alphabet. The device may generate the symbol sequence such that each symbol of the symbol sequence belongs to a second alphabet and has a second sequence length and a second sequence energy. In some examples, the device may calculate the approximation using an approximation formula. In some cases, the approximation formula may correspond to an approximation region from a feasible region associated with the first symbol alphabet.

### CROSS REFERENCE

This application is a 371 National Stage of PCT Application No. PCT/CN2023/071842, filed on Jan. 12, 2023, entitled “APPROXIMATION IN PROBABILISTIC CONSTELLATION SHAPING”, and assigned to the assignee hereof. The disclosure of the prior Application is considered part of and is incorporated by reference into this Patent Application.

### FIELD OF TECHNOLOGY

The following relates to wireless communications, including approximation in probabilistic constellation shaping (PCS).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support approximation in probabilistic constellation shaping (PCS). For example, the described techniques provide for a wireless device to implement PCS to encode a set of information bits to a symbol sequence based on an approximation of a logarithm of a cumulative sequence quantity. During a shaping procedure, the device may approximate the logarithm of the cumulative sequence quantity based on a normalized energy value, a saturated entropy function of the normalized energy value, a first sequence length, a first sequence energy, and a first symbol alphabet. The device may generate the symbol sequence such that each symbol of the symbol sequence belongs to a second alphabet and has a second sequence length and a second sequence energy that is less than or equal to an energy threshold. In some examples, the device may calculate the approximation using an approximation formula that includes one or more approximation terms.

In some cases, the device may determine a feasible region associated with the first symbol alphabet. The device may partition the feasible region into a set of approximation regions, where each approximation region corresponds to an approximation formula and one or more values of the first sequence length and the first sequence energy. The device may select an approximation region from the set of approximation regions based on a value of the first sequence length and a value of the first sequence energy. The device may approximate the logarithm of the cumulative sequence quantity using the approximation formula corresponding to the selected approximation region.

A method for wireless communications is described. The method may include obtaining a set of information bits for a shaping procedure, determining a normalized energy value for the shaping procedure based on a ratio between a first sequence length and a first sequence energy associated with the shaping procedure, determining a first approximation term for the shaping procedure based on a saturated entropy function of the normalized energy value and the first sequence length, determining a second approximation term for the shaping procedure based on the normalized energy value and a first symbol alphabet having a first alphabet size, determining, as part of the shaping procedure, an approximation of a logarithm of a cumulative sequence quantity associated with the first sequence length, the first sequence energy, and the first symbol alphabet, where the approximation is based on the first approximation term and the second approximation term, encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold, and transmitting a message including the symbol sequence based on the encoding.

An apparatus for wireless communications is described. The apparatus may include a processor, memory coupled with the processor, and instructions stored in the memory. The instructions may be executable by the processor to cause the apparatus to obtain a set of information bits for a shaping procedure, determine a normalized energy value for the shaping procedure based on a ratio between a first sequence length and a first sequence energy associated with the shaping procedure, determine a first approximation term for the shaping procedure based on a saturated entropy function of the normalized energy value and the first sequence length, determine a second approximation term for the shaping procedure based on the normalized energy value and a first symbol alphabet having a first alphabet size, determine, as part of the shaping procedure, an approximation of a logarithm of a cumulative sequence quantity associated with the first sequence length, the first sequence energy, and the first symbol alphabet, where the approximation is based on the first approximation term and the second approximation term, encode, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold, and transmit a message including the symbol sequence based on the encoding.

Another apparatus for wireless communications is described. The apparatus may include means for obtaining a set of information bits for a shaping procedure, means for determining a normalized energy value for the shaping procedure based on a ratio between a first sequence length and a first sequence energy associated with the shaping procedure, means for determining a first approximation term for the shaping procedure based on a saturated entropy function of the normalized energy value and the first sequence length, means for determining a second approximation term for the shaping procedure based on the normalized energy value and a first symbol alphabet having a first alphabet size, means for determining, as part of the shaping procedure, an approximation of a logarithm of a cumulative sequence quantity associated with the first sequence length, the first sequence energy, and the first symbol alphabet, where the approximation is based on the first approximation term and the second approximation term, means for encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold, and means for transmitting a message including the symbol sequence based on the encoding.

A non-transitory computer-readable medium storing code for wireless communications is described. The code may include instructions executable by a processor to obtain a set of information bits for a shaping procedure, determine a normalized energy value for the shaping procedure based on a ratio between a first sequence length and a first sequence energy associated with the shaping procedure, determine a first approximation term for the shaping procedure based on a saturated entropy function of the normalized energy value and the first sequence length, determine a second approximation term for the shaping procedure based on the normalized energy value and a first symbol alphabet having a first alphabet size, determine, as part of the shaping procedure, an approximation of a logarithm of a cumulative sequence quantity associated with the first sequence length, the first sequence energy, and the first symbol alphabet, where the approximation is based on the first approximation term and the second approximation term, encode, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold, and transmit a message including the symbol sequence based on the encoding.

In some examples of the method, apparatuses, and non-transitory computer-readable medium described herein, determining the approximation of the logarithm of the cumulative sequence quantity may include operations, features, means, or instructions for calculating the approximation of the logarithm of the cumulative sequence quantity according to an approximation formula including a summation of at least the first approximation term and the second approximation term.

Some examples of the method, apparatuses, and non-transitory computer-readable medium described herein may further include operations, features, means, or instructions for determining one or more additional approximation terms, where the approximation of the logarithm of the cumulative sequence quantity may be calculated based on the one or more additional approximation terms.

In some examples of the method, apparatuses, and non-transitory computer-readable medium described herein, the approximation formula may be based on the first alphabet size.

In some examples of the method, apparatuses, and non-transitory computer-readable medium described herein, each approximation term of the approximation formula may be scaled by a respective factor of the first sequence length.

Some examples of the method, apparatuses, and non-transitory computer-readable medium described herein may further include operations, features, means, or instructions for determining a third approximation term for the shaping procedure based on a centralized and scaled energy value and the first sequence length and determining a fourth approximation term for the shaping procedure based on the centralized and scaled energy value and the first sequence length, where the approximation of the logarithm of the cumulative sequence quantity may be determined based on a summation of the first approximation term, the second approximation term, the third approximation term, and the fourth approximation term.

Some examples of the method, apparatuses, and non-transitory computer-readable medium described herein may further include operations, features, means, or instructions for calculating the centralized and scaled energy value based on a product of a square root of the first sequence length and a difference between the normalized energy value and an average energy value associated with the first symbol alphabet.

Some examples of the method, apparatuses, and non-transitory computer-readable medium described herein may further include operations, features, means, or instructions for determining a third approximation term for the shaping procedure based on the normalized energy value and the first sequence length and determining a fourth approximation term for the shaping procedure based on the normalized energy value and the first sequence length, where the approximation of the logarithm of the cumulative sequence quantity may be determined based on a summation of the first approximation term, the second approximation term, the third approximation term, and the fourth approximation term.

In some examples of the method, apparatuses, and non-transitory computer-readable medium described herein, determining the first approximation term may include operations, features, means, or instructions for calculating a smooth function over an interval that may be associated with a threshold symbol energy of the first symbol alphabet.

In some examples of the method, apparatuses, and non-transitory computer-readable medium described herein, determining the second approximation term may include operations, features, means, or instructions for calculating a piecewise smooth function over an interval that may be associated with a threshold symbol energy of the first symbol alphabet.

In some examples of the method, apparatuses, and non-transitory computer-readable medium described herein, the first sequence length and the first sequence energy correspond to a feasible region associated with the first symbol alphabet.

In some examples of the method, apparatuses, and non-transitory computer-readable medium described herein, the first symbol alphabet may be a subset of the second symbol alphabet, the first sequence length may be less than or equal to the second sequence length, and the first sequence energy may be less than or equal to the energy threshold.

In some examples of the method, apparatuses, and non-transitory computer-readable medium described herein, the first symbol alphabet may be the same as the second symbol alphabet.

In some examples of the method, apparatuses, and non-transitory computer-readable medium described herein, the saturated entropy function may be based on the first symbol alphabet.

In some examples of the method, apparatuses, and non-transitory computer-readable medium described herein, the first approximation term may be a product of the first sequence length and a value of the saturated entropy function evaluated at the normalized energy value.

In some examples of the method, apparatuses, and non-transitory computer-readable medium described herein, the logarithm of the cumulative sequence quantity includes a logarithm of a total quantity of symbol sequences over the first symbol alphabet having the first alphabet size, each symbol sequence of the total quantity of symbol sequences may be associated with the first sequence length, and each symbol sequence of the total quantity of symbol sequences may be associated with a sequence energy that may be less than or equal to the first sequence energy.

A method for wireless communications at a wireless device is described. The method may include obtaining a set of information bits for a shaping procedure, determining an approximation region from a set of approximation regions for the shaping procedure based on a first sequence length and a first sequence energy associated with the shaping procedure, determining, as part of the shaping procedure, an approximation formula corresponding to the approximation region, the approximation formula including one or more approximation terms that are based on the first sequence length, the first sequence energy, and a first symbol alphabet having a first alphabet size, determining, as part of the shaping procedure and using the approximation formula, an approximation of a logarithm of a cumulative sequence quantity associated with the first sequence length, the first sequence energy, and the first symbol alphabet, encoding, as part of the shaping procedure, the set of information bits to obtain a symbol sequence based on the approximation of the logarithm of the cumulative sequence quantity, each symbol of the symbol sequence belonging to aa second symbol alphabet having a second alphabet size, where the symbol sequence has a second sequence length and a second sequence energy that is less than or equal to an energy threshold, and transmitting a message including at least the symbol sequence based on the encoding.

An apparatus for wireless communications at a wireless device is described. The apparatus may include a processor, memory coupled with the processor, and instructions stored in the memory. The instructions may be executable by the processor to cause the apparatus to obtain a set of information bits for a shaping procedure, determine an approximation region from a set of approximation regions for the shaping procedure based on a first sequence length and a first sequence energy associated with the shaping procedure, determine, as part of the shaping procedure, an approximation formula corresponding to the approximation region, the approximation formula including one or more approximation terms that are based on the first sequence length, the first sequence energy, and a first symbol alphabet having a first alphabet size, determine, as part of the shaping procedure and using the approximation formula, an approximation of a logarithm of a cumulative sequence quantity associated with the first sequence length, the first sequence energy, and the first symbol alphabet, encode, as part of the shaping procedure, the set of information bits to obtain a symbol sequence based on the approximation of the logarithm of the cumulative sequence quantity, each symbol of the symbol sequence belonging to aa second symbol alphabet having a second alphabet size, where the symbol sequence has a second sequence length and a second sequence energy that is less than or equal to an energy threshold, and transmit a message including at least the symbol sequence based on the encoding.

Another apparatus for wireless communications at a wireless device is described. The apparatus may include means for obtaining a set of information bits for a shaping procedure, means for determining an approximation region from a set of approximation regions for the shaping procedure based on a first sequence length and a first sequence energy associated with the shaping procedure, means for determining, as part of the shaping procedure, an approximation formula corresponding to the approximation region, the approximation formula including one or more approximation terms that are based on the first sequence length, the first sequence energy, and a first symbol alphabet having a first alphabet size, means for determining, as part of the shaping procedure and using the approximation formula, an approximation of a logarithm of a cumulative sequence quantity associated with the first sequence length, the first sequence energy, and the first symbol alphabet, means for encoding, as part of the shaping procedure, the set of information bits to obtain a symbol sequence based on the approximation of the logarithm of the cumulative sequence quantity, each symbol of the symbol sequence belonging to aa second symbol alphabet having a second alphabet size, where the symbol sequence has a second sequence length and a second sequence energy that is less than or equal to an energy threshold, and means for transmitting a message including at least the symbol sequence based on the encoding.

A non-transitory computer-readable medium storing code for wireless communications at a wireless device is described. The code may include instructions executable by a processor to obtain a set of information bits for a shaping procedure, determine an approximation region from a set of approximation regions for the shaping procedure based on a first sequence length and a first sequence energy associated with the shaping procedure, determine, as part of the shaping procedure, an approximation formula corresponding to the approximation region, the approximation formula including one or more approximation terms that are based on the first sequence length, the first sequence energy, and a first symbol alphabet having a first alphabet size, determine, as part of the shaping procedure and using the approximation formula, an approximation of a logarithm of a cumulative sequence quantity associated with the first sequence length, the first sequence energy, and the first symbol alphabet, encode, as part of the shaping procedure, the set of information bits to obtain a symbol sequence based on the approximation of the logarithm of the cumulative sequence quantity, each symbol of the symbol sequence belonging to aa second symbol alphabet having a second alphabet size, where the symbol sequence has a second sequence length and a second sequence energy that is less than or equal to an energy threshold, and transmit a message including at least the symbol sequence based on the encoding.

Some examples of the method, apparatuses, and non-transitory computer-readable medium described herein may further include operations, features, means, or instructions for determining a normalized energy value for the shaping procedure based on a ratio between the first sequence length and the first sequence energy, where determining the approximation region may be based on the normalized energy value.

Some examples of the method, apparatuses, and non-transitory computer-readable medium described herein may further include operations, features, means, or instructions for partitioning a feasible region associated with the first symbol alphabet into the set of approximation regions, where each approximation region of the set of approximation regions corresponds to one or more approximation formulas of a set of approximation formulas.

In some examples of the method, apparatuses, and non-transitory computer-readable medium described herein, each approximation formula of the set of approximation formulas includes at least one approximation term that may be based on a corresponding approximation region of the set of approximation regions.

Some examples of the method, apparatuses, and non-transitory computer-readable medium described herein may further include operations, features, means, or instructions for selecting the one or more approximation terms for the approximation formula based on the approximation region.

In some examples of the method, apparatuses, and non-transitory computer-readable medium described herein, each approximation term of the one or more approximation terms may be scaled by a respective factor of the first sequence length.

In some examples of the method, apparatuses, and non-transitory computer-readable medium described herein, the first symbol alphabet may be a subset of the second symbol alphabet, the first sequence length may be less than or equal to the second sequence length, and the first sequence energy may be less than or equal to the energy threshold.

In some examples of the method, apparatuses, and non-transitory computer-readable medium described herein, the first symbol alphabet may be the same as the second symbol alphabet.

In some examples of the method, apparatuses, and non-transitory computer-readable medium described herein, the logarithm of the cumulative sequence quantity includes a logarithm of a total quantity of symbol sequences over the first symbol alphabet having the first alphabet size, each symbol sequence of the total quantity of symbol sequences may be associated with the first sequence length, and each symbol sequence of the total quantity of symbol sequences may be associated with a sequence energy that may be less than or equal to the first sequence energy.

In some examples of the method, apparatuses, and non-transitory computer-readable medium described herein, determining the approximation of the logarithm of the cumulative sequence quantity may include operations, features, means, or instructions for determining a normalized energy value for the shaping procedure based on a ratio between the first sequence length and the first sequence energy, determining a first approximation term for the approximation formula based on a saturated entropy function of the normalized energy value and the first sequence length, and determining a second approximation term for the approximation formula based on the first symbol alphabet and the normalized energy value, where the approximation of the logarithm of the cumulative sequence quantity may be determined based on a summation of the first approximation term and the second approximation term.

Some examples of the method, apparatuses, and non-transitory computer-readable medium described herein may further include operations, features, means, or instructions for determining a third approximation term for the approximation formula based on a centralized and scaled energy value and the first sequence length and determining a fourth approximation term for the approximation formula based on the centralized and scaled energy value and the first sequence length, where the approximation of the logarithm of the cumulative sequence quantity may be determined based on a summation of the first approximation term, the second approximation term, the third approximation term, and the fourth approximation term.

Some examples of the method, apparatuses, and non-transitory computer-readable medium described herein may further include operations, features, means, or instructions for calculating the centralized and scaled energy value based on a product of a square root of the first sequence length and a difference between the normalized energy value and an average energy value associated with the first symbol alphabet.

### BRIEF DESCRIPTION OF THE DRAWINGS

FIG. 1 illustrates an example of a wireless communications system that supports approximation in probabilistic constellation shaping (PCS) in accordance with one or more aspects of the present disclosure.

FIG. 2 illustrates an example of a wireless communications system that supports approximation in PCS in accordance with one or more aspects of the present disclosure.

FIG. 3 illustrates an example of an encoding process that supports approximation in PCS in accordance with one or more aspects of the present disclosure.

FIGS. 4 through 6 illustrate examples of processing flows that support approximation in PCS in accordance with one or more aspects of the present disclosure.

FIGS. 7 and 8 illustrate block diagrams of devices that support approximation in PCS in accordance with one or more aspects of the present disclosure.

FIG. 9 illustrates a block diagram of a communications manager that supports approximation in PCS in accordance with one or more aspects of the present disclosure.

FIG. 10 illustrates a diagram of a system including a UE that supports approximation in PCS in accordance with one or more aspects of the present disclosure.

FIG. 11 illustrates a diagram of a system including a network entity that supports approximation in PCS in accordance with one or more aspects of the present disclosure.

FIGS. 12 and 13 illustrate flowcharts showing methods that support approximation in PCS in accordance with one or more aspects of the present disclosure.

### DETAILED DESCRIPTION

In some wireless systems, data may be modulated by a transmitting device for transmission to a receiving device by shaping the data into a constellation of modulated symbols. Each point in the constellation may represent one or more bits. In some cases, some wireless communications systems may utilize higher order modulation to increase spectral efficiency for wireless transmissions. In some cases, a distribution of modulated symbols may be shaped such that different symbols of a symbol constellation may have different probabilities of usage (e.g., some symbols may be more likely to be mapped to, and thus transmitted over the air, than other symbols). Such a distribution may be referred to as a non-uniform distribution of symbols. For example, modulation symbols associated with lower amplitudes may be selected with greater likelihood (and thus more often over time or in connection with a given set of bits) than modulation symbols associated with higher amplitudes, which may provide power savings, improved spectral efficiency, or other benefits.

The distribution of symbols may be shaped using one or more probabilistic shaping techniques. Probabilistic shaping may be a technique used to increase spectral efficiency of the coded modulation, and may generate non-uniformly distributed coded modulation symbols, or non-uniformly distributed constellations. In some examples, non-uniformly distributed symbols may have a higher capacity and may result in higher transmission capacities, higher spectral efficiencies, or generally higher communication quality than uniform symbol distributions. An example of a probabilistic shaping framework may be probabilistic amplitude shaping (PAS), also referred to as probabilistic constellation shaping (PCS), which may combine constellation shaping with channel coding techniques. PCS may shape an amplitude of a constellation of modulated symbols (e.g., the amplitude may be non-uniform).

Some shaping operations, or aspects of a shaping operation, however, may be computationally complex. For example, energy-based shaping schemes may rely on symbol energies of a symbol alphabet to which symbols of the symbol sequence belong. The non-uniform probability distribution of an energy-based shaping scheme may be proportional to the energy of a symbol associated with the scheme. In some cases, direct computation of variables and values used in an energy-based shaping scheme and associated with symbol energies may be highly complex, which may significantly increase power consumption and processing. Additionally, as the magnitudes of such values increase, storage complexity also increases. Thus, some energy-based shaping schemes may be prohibitively complex for some wireless devices.

The techniques described herein support reduced complexity (e.g., storage complexity, processing complexity) for shaping procedures at a wireless device. Rather than direct or explicit calculations (e.g., of variables or equations), the wireless device may determine one or more approximations for quantities utilized during a shaping procedure, thereby decreasing computational and processing power needed for the procedure. For example, the wireless device may approximate a logarithm of a cumulative sequence quantity based on a normalized energy value, a saturated entropy function of the normalized energy value, a first sequence length, a first sequence energy, and a first symbol alphabet. The wireless device may encode a set of information bits to a symbol sequence based on the approximation of the logarithm of the cumulative sequence quantity, where the symbol sequence has a second sequence length and a second sequence energy, and belongs to a second symbol alphabet. The first symbol alphabet may be a subset of the second symbol alphabet, the first sequence length may be less than or equal to the second sequence length, and the first sequence energy may be less than or equal to the second sequence energy. The wireless device may transmit a message including the symbol sequence based on the encoding.

In some examples, the wireless device may determine a formula for approximating the logarithm of the cumulative sequence quantity. The wireless device may, for example, determine a feasible region associated with the first symbol alphabet and may partition the feasible region into a set of approximation regions. Each approximation region may correspond to an approximation formula that includes one or more approximation terms. The wireless device may select an approximation region based on the first sequence length and the first sequence energy, and may calculate the approximation of the logarithm of the cumulative sequence quantity using the corresponding approximation formula.

Aspects of the disclosure are initially described in the context of wireless communications systems. Aspects of the disclosure are then discussed with reference to an encoding process. Aspects of the disclosure are further illustrated by and described with reference to apparatus diagrams, system diagrams, and flowcharts that relate to approximation in probabilistic constellation shaping.

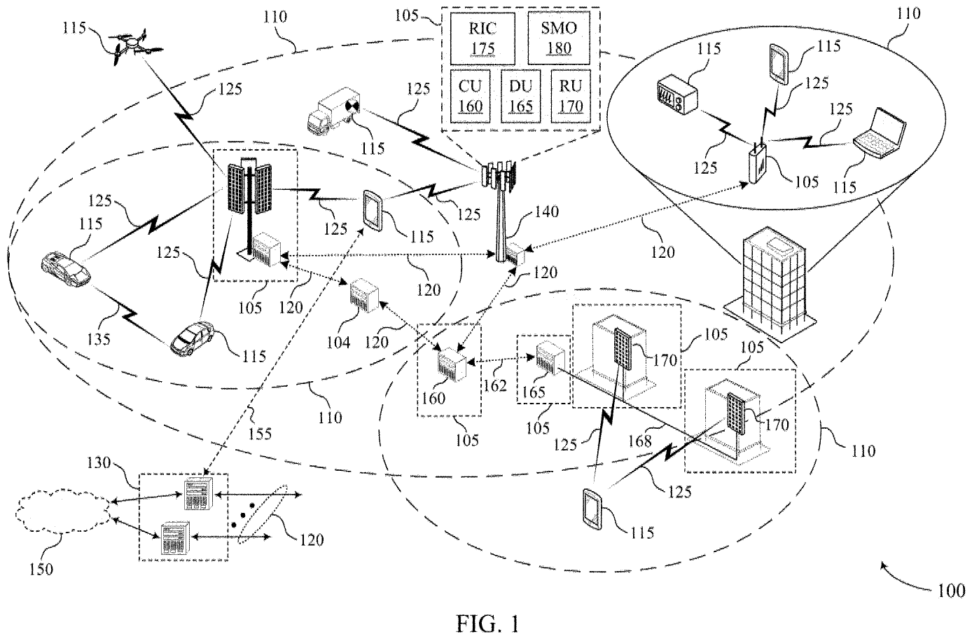

FIG. 1 illustrates an example of a wireless communications system 100 that supports approximation in PCS in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support approximation in PCS as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the wireless communications system 100, a wireless device (e.g., a UE 115, a network entity 105) may utilize PCS to modulate a signal. For example, transmitting and receiving devices may exchange information in the form of transport blocks (TBs), where a TB may refer to a payload passed from a MAC layer to a physical layer at a transmitting device or from a physical layer to a MAC layer at a receiving device. A transmitting device (e.g., a UE 115, a network entity 105) may modulate and encode a set of bits corresponding to (e.g., included in, assigned to) a TB using one or more distribution matchers as part of a shaping operation prior to transmitting the TB (e.g., a set of modulation symbols representing the TB) to a receiving device (e.g., a UE 115, a network entity 105). The one or more distribution matchers may convert the set of bits (e.g., k input bits) into a corresponding sequence of symbols (e.g., n symbols), where different symbols within a pool of possible symbols may have different associated probabilities of selection in accordance with a non-uniform probability distribution. For example, different symbols may correspond to different amplitudes (e.g., the symbols may be ASK symbols), and some amplitudes may be more likely to be included in the sequence of symbols than others based on the non-uniform probability distribution. PCS may therefore be implemented at the transmitting device by the one or more distribution matchers.

PCS may be used in combination with modulation schemes, such as APSK or QAM schemes, and may provide advantages when compared with other unshaped modulation types. For example, when unshaped modulation is used, each modulation symbol of a corresponding symbol constellation may be equally likely to be used and hence, over time, may be used equally often. Unshaped modulation may be based on a uniform probability distribution, as the probability of use is uniform across the different symbols of the symbol constellation. When PCS is used, however, different modulation symbols of a corresponding symbol constellation may have different probabilities of use; hence, the probability of use may be non-uniform across the different symbols of the symbol constellation. PCS may improve spectral efficiency and allow communications to more closely approach the Shannon's capacity (e.g., a theoretical maximum amount of information or data capacity that can be sent over a channel or medium). Additionally, or alternatively, PCS may improve power consumption. For example, modulation symbols with smaller amplitudes may be used more frequently than modulation symbols with larger amplitudes.

Thus, whereas an input set of k bits may be uniformly distributed, a corresponding sequence of n symbols obtained via a shaping procedure may be non-uniformly distributed, with some symbols more likely be to be included in the sequence of n symbols (e.g., appearing more often with the sequence) than others. A non-uniform sequence of symbols obtained via a shaping procedure may be converted to a corresponding bit sequence, and the corresponding bit sequence may be used for constellation mapping (e.g., mapping to the modulation symbols, such as QAM symbols, to achieve PAS). Symbols obtained via a shaping procedure may in some cases be referred to herein as interim symbols or shaped symbols (e.g., as opposed to modulation symbols, which may be transmitted over the air).

Some shaping operations, or aspects of a shaping operation, however, may be computationally complex. For example, energy-based shaping schemes may rely on symbol energies of a symbol alphabet to which symbols of the symbol sequence belong. The non-uniform probability distribution of an energy-based shaping scheme may be proportional to the energy of a symbol associated with the scheme. In some cases, direct computation of variables and values used in an energy-based shaping scheme and associated with symbol energies may be highly complex, which may significantly increase power consumption and processing. Additionally, as the magnitudes of such values increase, storage complexity also increases. Thus, some energy-based shaping schemes may be prohibitively complex.

The present disclosure describes techniques that support reduced computational complexity in PCS operations. A device may utilize one or more approximation methods discussed herein as part of a shaping procedure to obtain a symbol sequence based on a non-uniform probability distribution. Such approximation methods may enable the device to utilize PCS while avoiding increased processing, power consumption, and storage requirements. Additionally, the approximation methods may be associated with relatively high approximation accuracy.

For example, during a shaping procedure, the device may approximate a cumulative sequence quantity using an approximation formula. The cumulative sequence quantity may represent a set of all sequences having a first sequence length and a sequence energy that is less than or equal to a threshold sequence energy. The approximation formula may include one or more approximation terms, which may each be scaled by a respective factor of the first sequence length. The device may utilize the approximation of the cumulative sequence quantity to encode a set of information bits to a symbol sequence. In some cases, the device may additionally input the symbol sequence to a systematic forward error correction encoder (FEC). The encoded symbol sequence may be mapped to modulation symbols and transmitted, for example, to a receiving device.

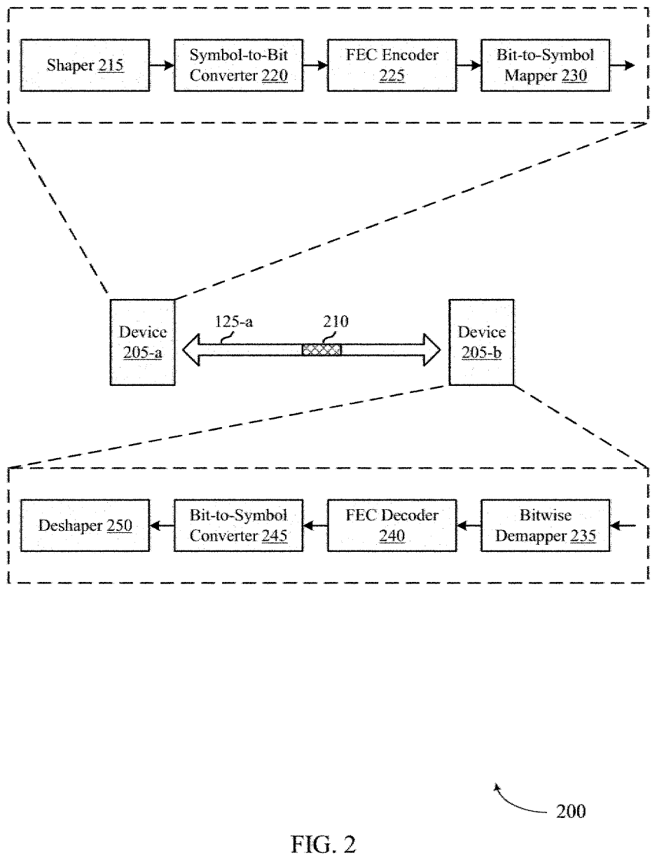

FIG. 2 illustrates an example of a wireless communications system 200 that supports approximation in PCS in accordance with one or more aspects of the present disclosure. In some examples, the wireless communications system 200 may implement aspects of wireless communications system 100. The wireless communications system 200 may include a device 205-a, which may include or be an example of a network entity 105, a UE 115, or any other device capable of transmitting wireless signals (e.g., as described with reference to FIG. 1). The wireless communications system 200 may also include a device 205-b, which may be an example of a network entity 105, a UE 115, or any other device capable of receiving wireless signals (e.g., as described with reference to FIG. 1).

In the example of FIG. 2, the device 205-a may operate as a transmitting device and may utilize PCS when communicating information to or from a receiving device, such as the device 205-b, via a communication link 125-a, which may be an example of a communication link 125 as described with reference to FIG. 1. For example, the device 205-a may process information bits of a TB 210 to obtain a corresponding set of modulation symbols. Processing the information bits may involve shaping, encoding, and modulating the information bits before mapping to a set of resources via which the TB 210 is to be transmitted. The device 205-a may transmit, via the communication link 125-a, signaling that is based on (e.g., includes or is otherwise modulated based on) the set of modulation symbols, in order to communicate the TB 210 to the device 205-b.

The information bits may be uniformly distributed. More specifically, a mapping table that maps blocks of incoming information bits to symbols to be transmitted may be configured such that a probability mass function (PMF) of symbols over constellation points of a modulation scheme is a uniform distribution. A constellation may be understood as a set of phase, frequency, and amplitude states of a signal (e.g., a signal transmitted by the device 205-a), where a constellation point represents a symbol corresponding to a phase value, a frequency value, and an amplitude value. As part of the processing, the device 205-a may shape the information bits using a shaper 215 between the source of the information bits and the mapper to constellation symbols. Probabilistic shaping, for example, may rely on the use of a code to vary the probability distribution of the constellation points. As an example, the device 205-a may apply probabilistic shaping such that constellation points associated with a lower energy are more likely to be used, while constellation points associated with a higher energy are less likely to be used. Probabilistic shaping may reduce the gap (referred to as a shaping gap) between the practically achievable capacity of a channel (e.g., the communication link 125-a) and the Shannon's capacity of the channel.

In some cases, the shaper 215 may include or be an example of an amplitude shaper that maps k information bits to n̅ amplitude symbols with a rate Rₐₛ=k/n̅. The amplitude shaper may be configured such that low-amplitude symbols are utilized more frequently than high-amplitude symbols, which may, in some cases, improve signal quality at the device 205-b, reduce a transmit power of the TB 210, or the like. The non-uniform distribution over the amplitude symbols generated by the amplitude shaper may be closer to the capacity-achieving input distribution than the uniform distribution. In some examples, the non-uniform distribution may be an example of a Maxwell-Boltzmann distribution.

During shaping, the shaper 215 may transform k information bits into n̅ interim symbols. For example, sequences within the k input bits may each be mapped to one or more corresponding interim symbols within an n̅-length sequence of interim symbols, which may also be referred to as a symbol sequence and represented by s^{n̅}. Thus, in some cases, each interim symbol may represent multiple input bits. Based on a non-uniform probability distribution associated with (e.g., used by) the shaper 215, different interim symbols within a pool of possible (e.g., candidate) interim symbols may not be equally likely to be included in the n̅-length sequence of interim symbols—that is, some interim symbols may be more likely to be included than others.

In general, a symbol sequence s output from a shaper (e.g., the shaper 215) may have a length n that is equal to the quantity of symbols in the symbol sequence. The symbols in the symbol sequence may belong to a symbol alphabet (e.g., a symbol constellation) denoted by [symbol] ₘ, where m indicates a size of the symbol alphabet (e.g., a quantity of discrete symbols belonging to the symbol alphabet). For example, in FIG. 2, the interim symbols may be ASK symbols (e.g., may belong to a symbol alphabet associated with an ASK constellation) and may be referred to as amplitude symbols. Thus, the symbol sequence s^{n̅} may be understood as a sequence of n̅ amplitude symbols.

Each symbol in a symbol alphabet [symbol] ₘ may have an energy, which may be referred to as a symbol energy. For example, the energy of a given ASK symbol may be based on or associated with an amplitude of the ASK symbol, and symbol energy may be greater for ASK symbols with relatively larger amplitudes. A symbol sequence s may be associated with a symbol alphabet [symbol] ₘ such that all symbols in s belong to the symbol alphabet [symbol] ₘ. A sequence energy E(s) for a sequence s may be calculated as a summation of the symbol energies associated with the symbols in the sequence s. A set of sequences [symbol] (m, n, E) may be defined as the set of all sequences of length n over the alphabet [symbol] ₘ, where each sequence in the set of sequences has an energy that is less than or equal to E. The total quantity of distinct sequences

$${N}_{c}^{[ m ]} ( n , E )$$

in the set [symbol] (m, n, E) may be referred as a cumulative sequence quantity, and may be defined by Equation 1 below, where the superscript m indicates the alphabet [symbol] ₘ and may be omitted if the alphabet is clear from context.

$${N}_{c}^{[ m ]} ( n , E ) = \vert 𝒮 ( m , n , E ) \vert \qquad ( 1 )$$

For a given alphabet size m, N_{c}(n, E) may be understood as a two-variable integer-valued function of n and E.

The shaper 215 may implement an energy-based shaping scheme (e.g., may have an energy-based PAS architecture) to obtain the symbol sequence s^{n̅}. For example, one or more distribution matchers of the shaper 215 may employ an encoding method, such as a direct energy-based arithmetic coding (AC) method, a two-stage peeling method, or the like, to efficiently encode the information bits to the symbol sequence s^{n̅}. Such encoding methods may rely on knowledge of N_{c}(n, E) for a wide range of values of n and E and, in some cases, one or more values of m. However, directly calculating N_{c}(n, E) may be prohibitively computationally complex (e.g., may be quadratic in n), such that some wireless devices may be unable to perform PCS or may be unable to do so efficiently. Additionally, values of N_{c}(n, E) may reach significantly large magnitudes, and some wireless devices may not have the storage capability to store all relevant values of N_{c}(n, E) for the wide range of values of n and E.

As such, the device 205-a (e.g., the shaper 215 of the device 205-a) may calculate an approximation of a logarithm of N_{c}(n, E) (e.g., may approximate log N_{c}(n, E)) in accordance with the techniques described herein, which may enable the device 205-a to implement energy-based shaping schemes more efficiently and effectively and with reduced computational complexity. Further, the approximation techniques described herein may maintain relatively high accuracy, such that performance degradation is avoided. The device 205-a may approximate the logarithm of N_{c}(n, E) with respect to any base, such as base 2, base e, or the like, among other examples, and a value representing the approximation of log N_{c}(n, E) may be referred to as log \hat{N}_{c}(n, E). For example, the approximation of log₂ N_{c}(n, E) may be represented by log₂ \hat{N}c (n, E); the approximation of log₂ N_{c}(n, E) may be represented by log₂ \hat{N}c (n, E); and the like.

In some examples, the shaper 215 may approximate log N_{c}(n, E) based on a normalized energy ω, a saturated entropy function H^{sat}(ω) of the normalized energy, a first sequence length n, a first sequence energy E, and a first symbol alphabet [symbol] ₘ to obtain log \hat{N}_{c}(n, E). In some cases, the shaper 215 may calculate log N_{c}(n, E) for a range of values of n and E and multiple values of m. In some examples, the shaper 215 may calculate multiple values of log N_{c}(n, E) (e.g., may approximate log N_{c}(n, E) multiple times).

The shaper 215 may, based on the approximation, generate the symbol sequence s^{n̅} such that the symbol sequence belongs to a second alphabet [symbol] _{m̅} and has a second sequence length n̅ and a second sequence energy. The second sequence energy may be less than or equal to an energy threshold, which may be represented by Ē. The first sequence length n, the first sequence energy E, and the first symbol alphabet [symbol] ₘ may be related to the second sequence length n̅, the energy threshold Ē, and the second symbol alphabet [symbol] ₘ. For example, the first symbol alphabet may be a subset of, or may be the same as, the second symbol alphabet. The first sequence length may be less than or equal to the second sequence length. Additionally, the first sequence energy may be less than or equal to the energy threshold.

The device 205-a may input the symbol sequence s^{n̅} to a symbol-to-bit converter 220. The symbol-to-bit converter 220 may convert interim symbols (e.g., symbols of the symbol sequence) into bits (e.g., a bit stream). In some cases, because the interim symbols are non-uniformly distributed, the bits output by the symbol-to-bit converter 220 may not be the same as the bits input to the shaper 215. For example, the symbol-to-bit converter 220 may output (M−1) bit sequences that include a quantity n̅(M−1) of bits, where M is a modulation order of the interim symbols (e.g., the quantity of different interim symbols within the pool of possible interim symbols may be equal to 2^{M}).

The device 205-a may input the converted bits to an encoder, such as an FEC encoder 225. The FEC encoder 225 may support error correction for the transmission of the TB 210 based on encoding redundancy. In some cases, the device 205-a may additionally input an unshaped subset of the information bits to the FEC encoder 225, such as a subset of γn̅ unshaped information bits. Based on the bits input to the FEC encoder 225, the FEC encoder 225 may generate systematic bits and parity bits. For example, the device 205-a may input the converted n̅(M−1) bits together with the γ unshaped information bits (e.g., for a total of n̅(M−1+γ) input bits) to the FEC encoder 225, which may have a rate R_{c}=(M−1+γ)/M. For every n̅(M−1+γ) input bits, the FEC encoder 225 may generate n̅(1−γ) parity bits. The n̅(1−γ) parity bits may, together with the γn̅ information bits, be converted to n̅ sign bits, which may then be pointwise multiplied with the n̅ amplitude symbols (e.g., with each symbol in the sequence s^{n̅}).

The device 205-a may input the bits output from the FEC encoder 225 to a constellation mapper, which may be based on a modulation scheme according to which the device 205-a is to modulate and transmit the TB 210. That is, the device 205-a may modulate the TB 210 according to a modulation format to represent the information conveyed by the transmission. For example, OFDM modulation may be based on modulating various subcarriers (e.g., using QAM modulation) and transmitting the modulated subcarriers in parallel (e.g., concurrent) using FDM techniques. In some examples, modulation symbols may refer to symbols based on any type of modulation, such as QAM symbols, binary phase shift keying (BPSK) symbols, quadrature phase shift keying (QPSK) symbols, amplitude and phase shift keying (APSK) symbols, or the like. In the example of FIG. 2, the device 205-a may implement modulation via a bit-to-symbol mapper 230. The bit-to-symbol mapper 230 may perform constellation mapping (e.g., map the bits input to the bit-to-symbol mapper 230 to corresponding modulation symbols, based on a symbol constellation associated with the modulation symbols). A subset of the bits input to the bit-to-symbol mapper 230 may be used to determine the amplitudes of the mapped-to modulation symbols, and these bits may be referred to as amplitude bits. Another subset of the bits input to the bit-to-symbol mapper 230 may be used to determine the signs (e.g., polarities, phases, or both) of the mapped-to modulation symbols, and these bits may be referred to as sign bits.

Because at least a portion of the bits input to the bit-to-symbol mapper 230 have been shaped, different modulation symbols within the symbol constellation used by the bit-to-symbol mapper 230 may have different likelihoods of being mapped to and transmitted over the air, and thus PCS may be implemented. For example, because the amplitude bits are based on the k information bits, the likelihood of a modulation symbol being mapped to may depend on the amplitude of the modulation symbol (e.g., lower amplitude modulation symbols, which may be nearer to a center of the symbol constellation, may be more likely to be mapped to than higher amplitude modulation symbols, which may be further from the center of the symbols constellation). In some cases, the device 205-a may multiply the amplitude bits with the sign bits and map the resulting products to the modulation symbols.

Modulation symbols corresponding to the TB 210 may be output by the bit-to-symbol mapper 230. The device 205-a may map the modulation symbols to a set of resources for transmission via the communication link 125-a. The device 205-a may then transmit the modulated symbols via the set of resources to convey the information represented by the bits of the TB 210. The device 205-b may receive, via the communication link 125-a, the modulation symbols corresponding to the TB 210.

The device 205-b may perform a decoding operation to process the TB 210 (e.g., to obtain the bits of the TB 210 based on the corresponding modulation symbols). The decoding operation performed by the device 205-b may be an inverse of the processing procedure performed by the device 205-a. For example, the device 205-b may input the received modulation symbols to a bitwise demapper 235 to obtain a set of bits corresponding to the modulation symbols. The set of bits may include systematic bits and parity bits. The device 205-b may input the set of bits to an FEC decoder 240 to extract the information bits, after which the device 205-b may convert the information bits to symbols via a bit-to-symbol converter 245. The bit-to-symbol converter 245 may output interim symbols (e.g., shaped symbols) corresponding to the shaped symbols output by the shaper 215 the device 205-a. The device 205-b may implement a deshaper 250 to recover the original information bits transmitted by the device 205-a. The deshaper 250 may utilize one or more deshaping procedures, which may accept, from the bit-to-symbol converter 245, an input sequence of interim symbols (e.g., n̅ interim symbols) and output a corresponding set of bits (e.g., k bits). The set of bits output by the deshaper 250 may correspond to the original information bits encoded by the device 205-a.

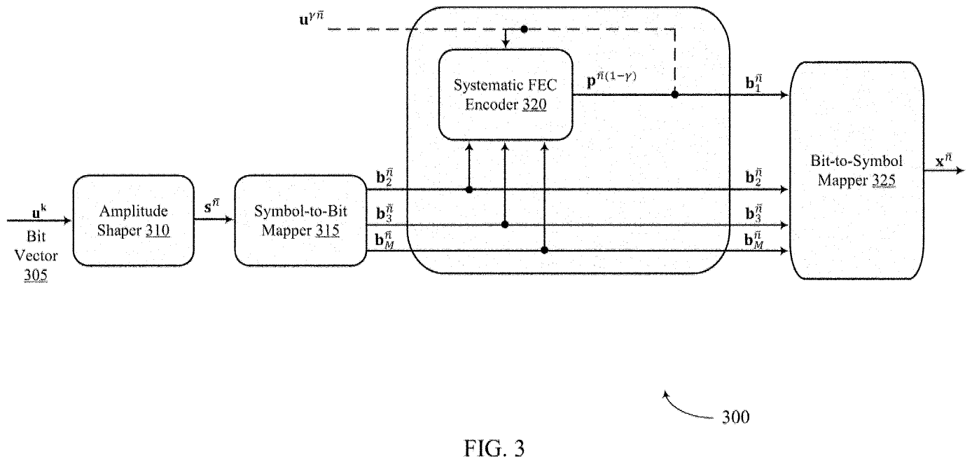

FIG. 3 illustrates an example of an encoding process 300 that supports approximation in PCS in accordance with one or more aspects of the present disclosure. In some examples, encoding process 300 may be implemented by aspects of wireless communications system 100 and wireless communications system 200. For example, a transmitting device (e.g., a device 205-a) may encode a message for transmission to a receiving device (e.g., a device 205-b) using PCS according to encoding process 300. The transmitting device may approximate one or more values of a cumulative sequence quantity as described herein as part of the encoding process 300.

The encoding process 300 may be understood as a transmitter chain that implements an energy-based PAS architecture. The encoding process 300 may include several stages by which the transmitting device processes (e.g., encodes) a set of k information bits (e.g., corresponding to a TB) for transmission to the receiving device, e.g., as described with reference to FIG. 2. In some examples, the transmitting device may transmit a TB as a set of CBs, where each CB may correspond to a portion of the information bits of the TB. In such examples, the transmitting device may process each CB individually according to the encoding process 300.

The encoding process 300 may include, for example, amplitude shaping (e.g., energy-based amplitude shaping), symbol-to-bit conversion, FEC, and bit-to-symbol mapping. Additionally, it is to be understood that the encoding process 300 is for illustrative purposes, and that some stages may be removed or additional stages may be included, such as attaching or appending one or more CRC bits, low-density parity-check code (LDPC) encoding, and resource mapping, among other possible stages. As illustrated, the encoding process 300 includes an amplitude shaper 310, a symbol-to-bit mapper 315, a systematic FEC encoder 320, and a bit-to-symbol mapper 325. The encoding process 300 may utilize ASK constellations with a modulation order 2^{M}. An ASK constellation may include constellation points in {±1, ±3, . . . , ±(2^{M}−1)} with an amplitude alphabet {1, 3, . . . , 2^{M}−1}. An amplitude alphabet may be an example of a symbol alphabet [symbol] ₘ as defined with reference to FIG. 2. The transmission rate of the encoding process 300 may be given by Rₜ=Rₐₛ+γ, where Rₐₛ is a rate of the amplitude shaper 310.

The transmitting device may obtain a set of k information bits in a bit vector 305 to be transmitted to a receiving device. The bit vector 305 including the k information bits may be represented by u^{k}, where u^{k}=(u₁, u₂, . . . , uₖ) (e.g., the bit vector 305 has a length k). The transmitting device may input the bit vector 305 to the amplitude shaper 310. The amplitude shaper 310 may have a rate Rₐₛ=k/n̅ and may map k information bits to n̅ amplitude symbols in a symbol sequence s^{n̅}. That is, the amplitude shaper 310 may induce a non-uniform distribution over the amplitude symbols, where the non-uniform distribution may be closer to a capacity-achieving input distribution than a uniform distribution. The non-uniform distribution may, in some examples, be a Maxwell-Boltzmann distribution, e.g., for an additive white gaussian noise (AWGN) channel.

To achieve a target non-uniform distribution that is close to the capacity-achieving input distribution, the amplitude shaper 310 may generate (e.g., encode) the symbol sequence s^{n̅} according to one or more constraints (e.g., conditions). For example, the amplitude shaper 310 may generate the symbol sequence s^{n̅} such that a sequence energy of s^{n̅} is below (e.g., less than) a threshold energy Ē. The amplitude shaper 310 may induce the target distribution over the amplitude symbols by selecting an appropriate threshold energy Ē.

A given symbol alphabet [symbol] ₘ may include a quantity m>1 of symbols a, such that [symbol] ₘ={a₁, a₂, . . . , aₘ}. The quantity m may be referred to as a size of the symbol alphabet [symbol] ₘ and may be based on the modulation order of the corresponding constellation, such that m=2^{(M-1)}. In some cases, symbols of the symbol alphabet [symbol] ₘ may be ordered. For instance, the symbols may be ordered such that dᵢ<aᵢ₊₁ for any i∈{1, 2, . . . , m−1} (e.g., a₁<a₂< . . . <aₘ). A symbol energy for each symbol aᵢ may be denoted as E(aᵢ). Respective symbol energies for each symbol in a symbol alphabet may be distinct, and each symbol of an ordered symbol alphabet may have a symbol energy that is less than a symbol energy of a subsequent symbol of the symbol alphabet. For example, it may be assumed that for any i∈{1, 2, . . . , m−1}, the symbol energies of the symbol alphabet may be defined by 0≤E(aᵢ)<E(aᵢ₊₁).

As an example, for an ASK constellation with a modulation order 2^{M}, an associated symbol alphabet may be defined as [symbol] ₘ={1, 3, . . . , 2^{M}−1}, where m=2^{(M-1)}. The ASK constellation may correspond to the symbol alphabet according to {−1, 1}× [symbol] ₘ. Put another way, the ASK constellation may include constellation points in {±1, ±3, . . . , ±(2^{M}−1)}. In this example, the symbols aᵢ of the symbol alphabet may be ordered such that aᵢ=2i−1 and a₁=1, a₂=3, . . . , aₘ=2^{M}−1. The symbol energies of the symbols may be represented by Equation 2 below.

$$E ( {a}_{i} ) = {( 2 i - 1 )}^{2} \qquad ( 2 )$$

Alternatively, because 8E(aᵢ)+1=(2i−1)², the symbol energies may be rescaled according to Equation 3 below.

$$E ( {a}_{i} ) = \frac{i ( i - 1 )}{2} \qquad ( 3 )$$

For the symbol alphabet [symbol] ₘ, and given a non-negative real number parameter β and a normalizing constant Z_{β}, the Maxwell-Boltzmann distribution (e.g., the target distribution) may be represented by a probability distribution having the form of Equation 4.

$${p}_{β} ( a ) = \frac{1}{{Z}_{β}} {e}^{- β E ( a )} , a ∈ {𝒜}_{m} \qquad ( 4 )$$

An optimized Maxwell-Boltzmann distribution over an ASK constellation associated with an alphabet [symbol] ₘ may provide large shaping gains compared to a uniform distribution over the same ASK constellation. That is, the optimized Maxwell-Boltzmann distribution may be closer to a capacity-achieving input distribution than the uniform distribution. A shaping gap may be defined as the gap between a given distribution and the capacity-achieving input distribution. Thus, implementing a shaping procedure based on the optimized Maxwell-Boltzmann distribution may reduce the shaping gap.

A symbol sequence s may be defined as a sequence of symbols s=(s₁, s₂, . . . , sₙ) having a sequence length n over a symbol alphabet [symbol] ₘ of size m. That is, the length of s may be equal to n, and each element (e.g., symbol) of s may belong to the alphabet [symbol] ₘ. The symbol sequence s may have a sequence energy denoted by E(s), which may be equivalent to an accumulation (e.g., a summation) of all symbol energies associated with the sequence. That is, as shown in Equation 5, E(s) may represent a summation of the respective symbol energies associated with each symbol sᵢ in the sequence s.

$$E ( s ) = {\sum }_{l = 1}^{n} E ( {s}_{l} ) \qquad ( 5 )$$

For the symbol alphabet [symbol] ₘ={a₁, a₂, . . . , aₘ}, each symbol aᵢ may have a symbol energy E(aᵢ) for each i∈{1, 2, . . . , m}. A set of sequences [symbol] (m, n, E) may include sequences that each have a length equal to n and are over [symbol] ₘ. Further, each sequence in [symbol] (m, n, E) may have a sequence energy E(s) that is less than or equal to a threshold energy E, which may be referred to as a threshold sequence energy, an energy threshold, or the like. This set of sequences may be mathematically defined by Equation 6.

$$𝒮 ( m , n , E ) {=}^{Δ} \{ s \vert {s}_{i} ∈ {𝒜}_{m} , i ∈ \{ 1 , 2 , ... , n \} , E ( s ) \leq E \} \qquad ( 6 )$$

A total quantity of distinct sequences in the set of sequences [symbol] (m, n, E) may be referred to as a cumulative sequence quantity

$${N}_{c}^{[ m ]} ( n , E ) ,$$

where m indicates the associated alphabet [symbol] ₘ. That is, the cumulative sequence quantity may be defined as

$${N}_{c}^{[ m ]} ( n , E ) = \vert 𝒮 ( m , n , E ) \vert .$$

The cumulative sequence quantity may indicate the cardinality of the set of sequences [symbol] (m, n, E). In some cases, the alphabet [symbol] ₘ may be implicitly indicated (e.g., from context) and the cumulative sequence quantity may be represented by N_{c}(n, E). N_{c}(n, E) may generally indicate a total quantity of symbol sequences over a symbol alphabet [symbol] ₘ having an alphabet size m, each symbol sequence having a respective sequence length n and a respective sequence energy that is less than or equal to a sequence energy E. Put another way, N_{c}(n, E) may represent a total quantity of symbol sequences that each satisfy three properties. First, each symbol sequence within the total quantity N_{c}(n, E) has a length n. Second, each element (i.e., symbol) of each symbol sequence within N_{c}(n, E) belongs to a same alphabet (i.e., [symbol] ₘ) having a size m. Third, each symbol sequence within N_{c}(n, E) may have a sequence energy E(s) that is less than or equal to a threshold sequence energy E. For a given value of m, N_{c}(n, E) may be understood as a two-variable integer-valued function of n and E.

N_{c}(n, E) may be more generally defined based on a univariate polynomial Z₀(x) given by Equation 7.

$${Z}_{0} ( x ) = {\sum }_{i = 1}^{m} {\text{?}}_{i} {x}^{E ( {a}_{i} )} \qquad ( 7 )$$

Assuming that E(aᵢ) is a non-negative integer for each i, and that the coefficient [symbol] ᵢ is non-negative and real-valued for each i, the polynomial Z₀ may be considered admissible if Z₀>0 and if the greatest common divisor of all E(aᵢ), when i≥2, is equal to 1. Here, N(n, E) may be defined as the coefficient of x^{E(a}^{ᵢ}⁾ in the polynomial Z₀(x)ⁿ. That is, the polynomial Z₀(x) may be raised to the n^{th} power, and N(n, E) may be the coefficient of x for a given value of E(aᵢ). N(n, E) for a given alphabet [symbol] ₘ may be represented by Equation 8 below, where the superscript m indicates the alphabet [symbol] ₘ and may be omitted if the alphabet is clear from context.

$${N}^{[ m ]} ( n , E ) = coeff \{ {x}^{E} \vert {( {\sum }_{i = 1}^{m} {\text{?}}_{i} {x}^{E ( {a}_{i} )} )}^{n} \} \qquad ( 8 )$$

With this definition of N(n, E), N_{c}(n, E) may be understood as the sum of all N(n, E′), where the value of E′ ranges from 0 to E. For example, for a given alphabet [symbol] ₘ, N_{c}(n, E) may be given by Equation 9.

$${N}_{c}^{[ m ]} ( n , E ) = {\sum }_{i = 0}^{E} {N}^{[ m ]} ( n , E - i ) \qquad ( 9 )$$

The amplitude shaper 310 may encode the k information bits in the bit vector 305 (e.g., in u^{k}) to a symbol sequence s^{n̅}=(s₁, s₂, . . . , s_{n̅}) using an energy-based shaping scheme, which may be based on or otherwise utilize one or more values of

$${N}_{c}^{[ m ]} ( n , E ) .$$

More specifically, for a given symbol alphabet [symbol] _{m̅} of a size m̅, a given sequence length n̅, and a given energy threshold Ē (e.g., a maximum sequence energy Ē), the amplitude shaper 310 may encode the bits in u^{k} to a symbol sequence s^{n̅} in a set of symbol sequences [symbol] (m̅, n̅, Ē). The symbol sequence s^{n̅} may belong to the set of symbol sequences [symbol] (m̅, n̅, Ē), where each symbol sequence in the set of symbol sequences [symbol] (m̅, n̅, Ē) has a sequence length n̅ and a respective sequence energy less than or equal to the energy threshold Ē, and where each symbol in each symbol sequence belongs to the alphabet [symbol] _{m̅}.

Encoding methods implemented by the amplitude shaper 310 to shape information bits of the bit vector 305 may induce an injective mapping from the set of all 2^{k} information bit sequences to [symbol] (m̅, n̅, Ē), where such encoding methods may rely on one or more values of N_{c}(n, E). As discussed herein, the variables n, m, and E may represent changing (e.g., dynamic) values of sequence length, alphabet size, and energy threshold, respectively, which may be used during calculation or approximation of the quantity N_{c}(n, E). Bar variables such as n̅, m̅, and Ē may represent explicit values (e.g., configured parameters) for a sequence length, alphabet size, and energy threshold, respectively, such as for a specific symbol sequence s^{n̅} that is encoded based on the approximation of N_{c}(n, E). For example, an alphabet [symbol] ₘ with the alphabet size m may be utilized during approximation of

$${N}_{c}^{[ m ]} ( n , E ) ,$$

while an alphabet [symbol] _{m̅} may be associated with the symbol sequence s^{n̅} output by the amplitude shaper 310. Additionally, the alphabet [symbol] ₘ and the alphabet [symbol] _{m̅} may be related, such that 1<m≤m̅ (e.g., the alphabet [symbol] ₘ may be a subset of, or may be the same as, the alphabet [symbol] _{m̅}).

In some cases, during shaping, the variables n, m, and E may be initialized at the values n̅, m̅, and Ē, respectively. In some examples, m̅ may be related to a modulation order of the encoding process 300. For example, for QAM-64, m̅ may be equal to 4, while for QAM-256, m̅ may be equal to 8.

The amplitude shaper 310 may calculate an approximation (e.g., an approximate value) of a logarithm of N_{c}(n, E) based on n, m, and E to obtain a symbol sequence s^{n̅} having a sequence length n̅ and a sequence energy less than or equal to Ē over an alphabet [symbol] _{m̅} of size m̅. More specifically, to encode the bit vector 305 to the symbol sequence s^{n̅}, the amplitude shaper 310 (e.g., a distribution matcher of the amplitude shaper 310) may utilize the techniques described herein to approximate a logarithm of N_{c}(n, E) (where the approximation may be represented by log \hat{N}c (n, E)) for one or more values of n, E, and m, respectively, where 1<m≤m̅, 0≤n≤n̅ and 0≤E≤Ē. In some examples, the amplitude shaper 310 may calculate one or more approximations of log N_{c}(n, E) (e.g., one or more values of the approximation log \hat{N}_{c}(n, E)) to obtain the symbol sequence s^{n̅}.

For a symbol alphabet [symbol] ₘ={a₁, a₂, . . . , aₘ}, the energy of each symbol aᵢ may be represented by E(aᵢ), where E(aₘ) corresponds to a maximum symbol energy of the symbol alphabet. A feasible region [symbol] ₘ associated with [symbol] ₘ may be defined by Equation 10, where nₘᵢₙ and nₘₐₓ are integers such that 1≤nₘᵢₙ≤nₘₐₓ.

$${ℛ}_{m} = \{ ( n , E ) ∈ {ℕ}^{2} \vert {n}_{min} \leq n \leq {n}_{max} , 1 \leq E \leq nE ( {a}_{m} ) \} \qquad ( 10 )$$

The transmitting device (e.g., the amplitude shaper 310 of the transmitting device) may partition the feasible region [symbol] ₘ into one or more subsets, which may be referred to as approximation regions. A total quantity of approximating regions may be denoted as Kₘ. For example, the feasible region [symbol] ₘ may be partitioned as illustrated by Equation 11, where each approximating region

$${\text{?}}_{i}^{[ m ]}$$

is an i^{th} approximating region associated with the symbol alphabet [symbol] ₘ. If the symbol alphabet is indicated by context,

$${\text{?}}_{i}^{[ m ]}$$

may be written as [symbol] ᵢ.

$${ℛ}_{m} = {{⋃}_{i = 1}}^{{K}_{m}} {\text{?}}_{i}^{[ m ]} \qquad ( 11 )$$

For one or more values of each of n and E within the feasible region [symbol] ₘ, a normalized energy ω may be defined as a ratio of E to n (e.g., ω=E/n). A uniform energy ω^{u} associated with the symbol alphabet [symbol] ₘ may be defined as the summation of all symbol energies of the symbol alphabet [symbol] ₘ normalized by the alphabet size m, as shown in Equation 12.

$${ω}^{u} = \frac{1}{m} {\sum }_{i = 1}^{m} E ( {a}_{i} ) \qquad ( 12 )$$

ω^{u} may also be understood as an average energy over [symbol] ₘ. Further, a centralized and scaled energy ν may be defined as a multiplication of a square root of the sequence length n and a difference between the normalized energy ω and the average energy ω^{u} associated with [symbol] ₘ. That is, for (n, E)∈ [symbol] ₘ, let ν=\sqrt{n}(ω−ω^{u}).

The transmitting device (e.g., the amplitude shaper 310 of the transmitting device) may determine log \hat{N}_{c}(n, E) based on the feasible region [symbol] ₘ, the one or more values of each of n, m, and E, the normalized energy ω, the centralized scaled energy ν, or any combination thereof, as part of the encoding process 300. For example, during shaping, the amplitude shaper 310 may determine log \hat{N}_{c}(n, E) based on an approximation formula that includes one or more approximation terms. In some cases, the approximation formula may be a summation of a set of approximation terms. Additionally, in some examples, each of the one or more approximation terms may be scaled by a factor of the sequence length n. In some aspects, the amplitude shaper 310 may determine multiple values of log \hat{N}_{c}(n, E) (e.g., may determine multiple approximations of log N_{c}(n, E)). Based on log \hat{N}_{c}(n, E), the amplitude shaper 310 may encode the bit vector 305 to the symbol sequence s^{n̅}.

For example, the amplitude shaper 310 may determine or otherwise calculate a value of a normalized energy ω based on a first sequence length n and a first sequence energy E. The amplitude shaper 310 may determine a first approximation term based on ω and n and a second approximation term based on ω and a first symbol alphabet [symbol] ₘ. The amplitude shaper 310 may determine (e.g., calculate) log \hat{N}_{c}(n, E) based on a summation of the first approximation term and the second approximation term. The amplitude shaper 310 may encode the bit vector 305 to obtain the symbol sequence s^{n̅}, where the symbol sequence s^{n̅} has a second sequence length n̅ and a second sequence energy that is less than or equal to an energy threshold Ē, and where each symbol within s^{n̅} belongs to a second symbol alphabet [symbol] _{m̅} of size m̅.

In some cases, the first sequence length n, the first sequence energy E, and the first symbol alphabet [symbol] ₘ may be related to the second sequence length n̅, the energy threshold Ē, and the second symbol alphabet [symbol] _{m̅}. For example, the first symbol alphabet [symbol] ₘ may be a subset of, or may be the same as, the second symbol alphabet [symbol] _{m̅}, and m may be less than or equal to m̅. Additionally, the first sequence length n may be less than or equal to the second sequence length n̅, and the first sequence energy E may be less than or equal to the energy threshold Ē.

The amplitude shaper 310 may output the symbol sequence s^{n̅}, which may be input (e.g., by the transmitting device) to the symbol-to-bit mapper 315. The symbol-to-bit mapper 315 may convert the symbols of the symbol sequence s^{n̅} into amplitude bits, e.g., into one or more bit streams

$${b}_{i}^{\overline{n}} .$$

The quantity of bits and bit streams

$${b}_{i}^{\overline{n}}$$

may be based on the modulation order 2^{M} of the encoding process 300, where the symbol-to-bit mapper 315 may output (M−1) bit streams, each bit stream including n̅ bits. As illustrated in FIG. 3, for M=4, the symbol-to-bit mapper 315 may output a first bit stream

$${b}_{2}^{\overline{n}} ,$$

a second bit stream

$${b}_{3}^{\overline{n}} ,$$

and a third bit stream

$${b}_{4}^{\overline{n}} ,$$

for a total of n̅(M−1) amplitude bits.

The bit streams may be input to the systematic FEC encoder 320. In some examples, a subset of the u^{k} information bits (e.g., a subset of unshaped information bits) may be input to the systematic FEC encoder 320 together with the bit streams. For example, the transmitting device may input γn̅ unshaped information bits, represented by u^{γn̅}, to the systematic FEC encoder 320, along with the n̅(M−1) amplitude bits output by the symbol-to-bit mapper 315, for a total of n̅(M−1+γ) input bits. The systematic FEC encoder 320 may have a coding rate given by R_{c}=(M−1+γ)/M and may output (e.g., generate) n̅(1−γ) parity bits. The parity bits output by the systematic FEC encoder 320 may be represented by a bit vector p^{n̅(1−γ)}.

The parity bits p^{n̅(1−γ)} and the unshaped information bits urn may be used as n̅ sign bits in a bit stream

$${b}_{1}^{\overline{n}} .$$

The bit streams

$${b}_{1}^{\overline{n}} , {b}_{2}^{\overline{n}} , {b}_{3}^{\overline{n}} , and {b}_{4}^{\overline{n}}$$

may be input to a bit-to-symbol mapper 325, which may map the amplitude bits and the n̅ sign bits to constellation points of the ASK constellation. The output of the bit-to-symbol mapper 325 may be a vector x^{n̅}. The transmitting device may transmit a message including x^{n̅} to the receiving device.

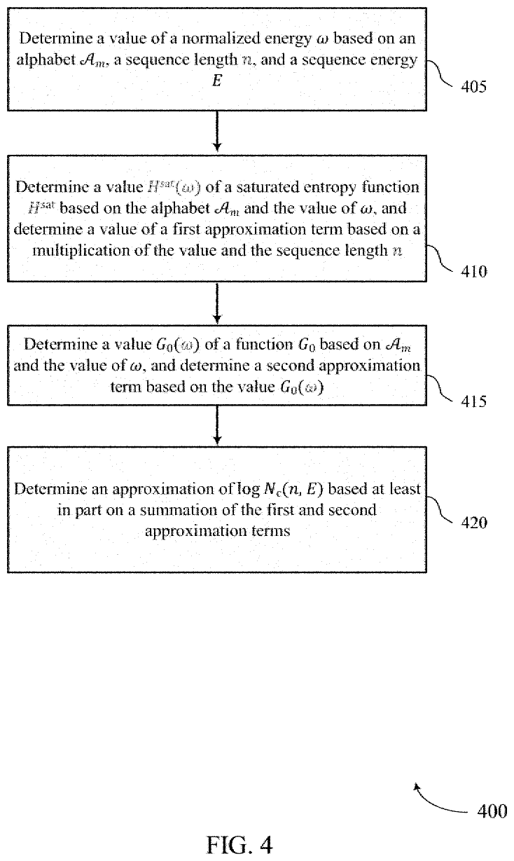

FIG. 4 illustrates an example of a processing flow 400 that supports approximation in PCS in accordance with one or more aspects of the present disclosure. In some examples, processing flow 400 may be implemented by aspects of wireless communications system 100 and wireless communications system 200. For example, a transmitting device (e.g., a device 205-a) may encode a message for transmission to a receiving device (e.g., a device 205-b) using PCS according to processing flow 400. The processing flow 400 may include several stages by which the transmitting device processes (e.g., encodes) a set of k information bits (e.g., corresponding to a TB) for transmission to the receiving device, e.g., as described with reference to FIGS. 2 and 3.

The processing flow 400 illustrates an example approximation method by which the transmitting device may approximate one or more values of a logarithm of a cumulative sequence quantity log N_{c}(n, E), where the approximation is denoted by log \hat{N}_{c}(n, E). As described with reference to FIG. 3, the transmitting device may encode the k information bits to obtain a symbol sequence based on the approximation. In FIG. 4, the transmitting device may determine log \hat{N}_{c}(n, E) using an approximation formula that includes at least two approximation terms.

For a first symbol alphabet [symbol] ₘ and an associated feasible region [symbol] ₘ (e.g., defined by Equation 10), symbols of [symbol] ₘ may each have a symbol energy E(aᵢ), where E(aₘ) is a maximum symbol energy associated with [symbol] ₘ. The transmitting device may determine one or more values of a first sequence length n and one or more values of a first sequence energy E, such that (n, E)∈ [symbol] ₘ. At 405, the transmitting device may determine a value of a normalized energy ω (e.g., ω=E/n) based on the first sequence length, the first sequence energy, and the first symbol alphabet [symbol] ₘ.

At 410, the transmitting device may evaluate a saturated entropy function H^{sat} at the value of the normalized energy ω, e.g., may evaluate H^{sat}(ω). The saturated entropy function H^{sat} may be an example of a smooth function defined over the interval [0, E(aₘ)]. When the value of the normalized energy ω is less than or equal to an average energy ω^{u} over [symbol] ₘ, H^{sat}(ω) is equal to a value of the Shannon entropy associated to a Maxwell-Boltzmann distribution over [symbol] ₘ and with parameter β, where β is equal to the first-order derivative of the saturated entropy function H^{sat} evaluated at the value of the normalized energy ω. Alternatively, when the value of the normalized energy ω is greater than the average energy ω^{u} over [symbol] ₘ, H^{sat}(ω) is equal to a logarithm of a size of [symbol] ₘ. That is, in such cases, H^{sat}(ω) may be constant (e.g., regardless of the value of the normalized energy ω) and may be equal to log m. The transmitting device may determine a value of a first approximation term by scaling H^{sat}(ω) by the first sequence length n. That is, the first approximation term may be equal to nH^{sat}(ω), and the transmitting device may evaluate the first approximation term at the values of n and ω.

At 415, the transmitting device may evaluate a function G₀ at the value of ω based on the first symbol alphabet [symbol] ₘ, e.g., may evaluate G₀(ω). The function G₀ may be a piecewise smooth function of the interior of [0, E(aₘ)]. The second approximation term may be equal to G₀(ω).

At 420, the transmitting device may determine the approximation of log N_{c}(n, E) (e.g., may calculate log \hat{N}_{c}(n, E)) based on a summation of the first approximation term and the second approximation term. The transmitting device may utilize the approximation as part of a shaping procedure to encode the set of information bits to the symbol sequence. In some examples, the transmitting device may perform the processing flow 400 repeatedly to obtain multiple values of log \hat{N}_{c}(n, E) for use in the shaping procedure.

Processing flow 400 provides an illustrative example of an approximation method for determining log \hat{N}_{c}(n, E), though it is to be understood that additional steps may be added. For example, the transmitting device may determine additional approximation terms based on one or more additional functions, a centralized and scaled energy value ν=\sqrt{n}(ω−ω^{u}), or the like. In some cases, each approximation term may be scaled by a factor of the sequence length n and may depend on E. In such examples, the second approximation term G₀(ω) may be understood to be scaled by n⁰.

For example, the transmitting device may calculate log \hat{N}_{c}(n, E) based on an approximation formula given by Equation 13. This approximation formula includes the first approximation term H^{sat}(ω), the second approximation term G₀(ω), a third approximation term

$${G}_{0}^{s} ( v ) ,$$

a fourth approximation term

$${G}_{\frac{1}{2}}^{s} ( v ) ,$$

a fifth approximation term G₁(ω), a sixth approximation term

$${G}_{1}^{s} ( v ) ,$$

and a seventh approximation term c(E). Additionally, each approximation term may be scaled by a respective factor of the sequence length n. For example, the first approximation term may be scaled by n, the second and third approximation terms may each be scaled by n⁰, the fourth approximation term may be scaled by

$$\frac{1}{\sqrt{n}} ,$$

the fifth approximation term may be scaled by 1/n, and the seventh approximation term may be scaled by n⁰.

$$log {\hat{N}}_{c} ( n , E ) = {nH}^{sat} ( ω ) + {G}_{0} ( ω ) + {G}_{0}^{s} ( v ) + \frac{1}{\sqrt{n}} {G}_{\frac{1}{2}}^{s} ( v ) + \frac{1}{n} {G}_{1} ( ω ) + \frac{1}{n} {G}_{1}^{s} ( v ) + c ( E ) \qquad ( 13 )$$

When using the approximation formula given by Equation 13, the transmitting device may determine the third, fourth, and sixth approximation terms by evaluating each of the functions of

$${G}_{0}^{s} ( v ) , {G}_{\frac{1}{2}}^{s} ( v ) , and {G}_{1}^{s} ( v ) ,$$

respectively, at a value of the centralized and scaled energy value ν. The functions

$${G}_{0}^{s} ( v ) , {G}_{\frac{1}{2}}^{s} ( v ) , and {G}_{1}^{s} ( v )$$

may be smooth functions over the real line [symbol] . G₁(ω) may be a piecewise smooth function over the interior of [0, E(aₘ)] and may be evaluated at the value of ω. c(E) may be a real-valued function defined on [symbol] and evaluated at the value of E. The approximation formula may be understood as a decoupled sum of one or more approximating terms, where each term has a characteristic dependence on n and the corresponding function.

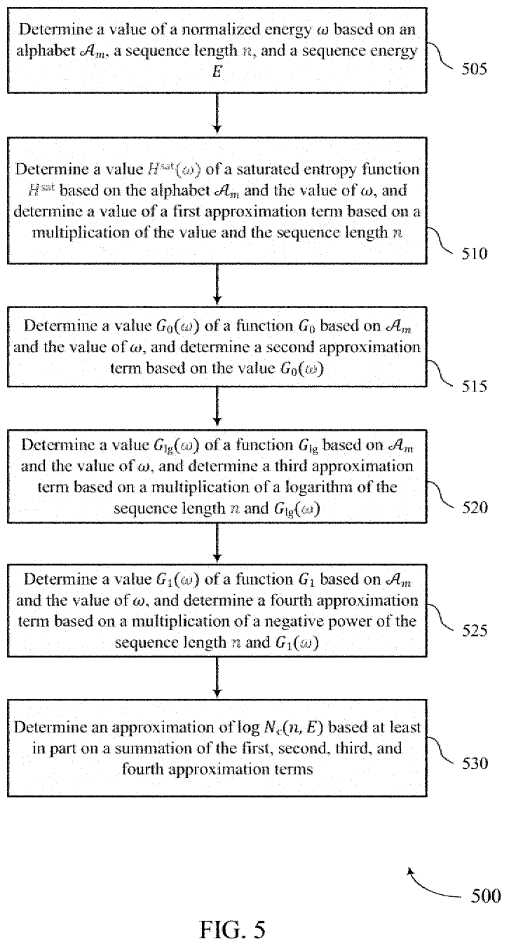

FIG. 5 illustrates an example of a processing flow 500 that supports approximation in PCS in accordance with one or more aspects of the present disclosure. In some examples, processing flow 500 may be implemented by aspects of wireless communications system 100 and wireless communications system 200. For example, a transmitting device (e.g., a device 205-a) may encode a message for transmission to a receiving device (e.g., a device 205-b) using PCS according to processing flow 500. The processing flow 500 may include several stages by which the transmitting device processes (e.g., encodes) a set of k information bits (e.g., corresponding to a TB) for transmission to the receiving device, e.g., as described with reference to FIGS. 2 and 3.

The processing flow 500 illustrates an example approximation method by which the transmitting device may approximate one or more values of a logarithm of a cumulative sequence quantity log N_{c}(n, E), where the approximation is denoted by log \hat{N}_{c}(n, E). As described with reference to FIG. 3, the transmitting device may encode the k information bits to obtain a symbol sequence based on the approximation. In FIG. 5, the transmitting device may determine log \hat{N}_{c}(n, E) using an approximation formula that includes at least four approximation terms.

For a first symbol alphabet [symbol] ₘ and an associated feasible region [symbol] ₘ (e.g., defined by Equation 10), symbols of [symbol] ₘ may each have a symbol energy E(aᵢ), where E(aₘ) is a maximum symbol energy associated with [symbol] ₘ. The transmitting device may determine one or more values of a first sequence length n and one or more values of a first sequence energy E, such that (n, E)∈ [symbol] ₘ. At 505, the transmitting device may determine a value of a normalized energy ω (e.g., ω=E/n) based on the first sequence length, the first sequence energy, and the first symbol alphabet [symbol] ₘ.

At 510, the transmitting device may evaluate a saturated entropy function H^{sat} at the value of the normalized energy ω, e.g., may evaluate H^{sat}(ω). The saturated entropy function H^{sat} may be an example of a smooth function defined over the energy [0, E(aₘ)]. The transmitting device may determine a value of a first approximation term by scaling H^{sat}(ω) by the first sequence length n. That is, the first approximation term may be equal to nH^{sat}(ω), and the transmitting device may evaluate the first approximation term at the values of n and ω.

At 515, the transmitting device may evaluate a function G₀ at the value of ω based on the first symbol alphabet [symbol] ₘ, e.g., may evaluate G₀(ω). The function G₀ may be an alternative piecewise smooth function of the interior of [0, E(aₘ)]. The second approximation term may be equal to G₀(ω).

At 520, the transmitting device may evaluate a function G_{lg} at the value of ω based on the first symbol alphabet [symbol] ₘ, e.g., may evaluate G_{lg}(ω). The function G_{lg} may be a piecewise smooth function of the interior of [0, E(aₘ)]. The transmitting device may determine a value of a third approximation term by scaling G_{lg}(ω) by a logarithm of n. That is, the third approximation term may be equal to G_{lg}(ω) log n.

At 525, the transmitting device may evaluate a function G₁ at the value of ω based on the first symbol alphabet [symbol] ₘ, e.g., may evaluate G₁(ω). The function G₁ may be an alternative piecewise smooth function of the interior of [0, E(aₘ)]. The transmitting device may determine a value of a fourth approximation term by scaling G₁(ω) by a negative power of n. That is, the fourth approximation term may be equal to

$$\frac{1}{n} {G}_{1} ( ω ) .$$

At 530, the transmitting device may determine the approximation of log N_{c}(n, E) (e.g., may calculate log \hat{N}_{c}(n, E)) based on a summation of the first approximation term, the second approximation term, the third approximation term, and the fourth approximation term. The transmitting device may utilize the approximation as part of a shaping procedure to encode the set of information bits to the symbol sequence. In some examples, the transmitting device may perform the processing flow 500 repeatedly to obtain multiple values of log \hat{N}_{c}(n, E) for use in the shaping procedure.

Processing flow 500 provides an illustrative example of an approximation method for determining log \hat{N}_{c}(n, E), though it is to be understood that additional steps may be added. For example, the transmitting device may determine additional approximation terms based on one or more additional functions, a centralized and scaled energy value ν=\sqrt{n}(ω−ω^{u}), or the like. In some cases, each approximation term may scaled by a factor of the sequence length n and may depend on E. In such examples, the second approximation term G₀(ω) may be understood to be scaled by n⁰.

For example, the transmitting device may calculate log \hat{N}_{c}(n, E) based on an approximation formula given by Equation 14. This approximation formula includes the first through fourth approximation terms of processing flow 500, as well as a fifth approximation term c(E). c(E) may be a real-valued function defined on N and evaluated at the value of E.

$$log {\hat{N}}_{c} ( n , E ) = {nH}^{sat} ( ω ) + {G}_{lg} ( ω ) log n + {G}_{0} ( ω ) + \frac{1}{n} {G}_{1} ( ω ) + c ( E ) \qquad ( 14 )$$

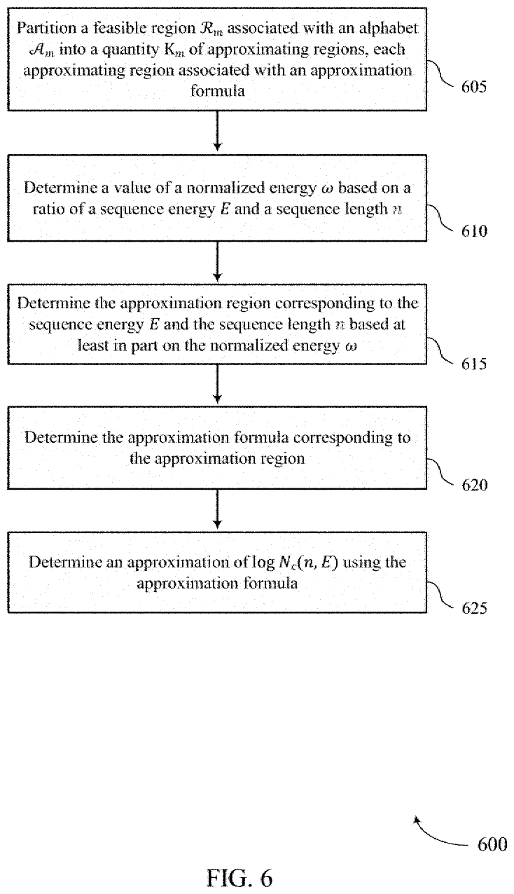

FIG. 6 illustrates an example of a processing flow 600 that supports approximation in PCS in accordance with one or more aspects of the present disclosure. In some examples, processing flow 600 may be implemented by aspects of wireless communications system 100 and wireless communications system 200. For example, a transmitting device (e.g., a device 205-a) may encode a message for transmission to a receiving device (e.g., a device 205-b) using PCS according to processing flow 600. The processing flow 600 may include several stages by which the transmitting device processes (e.g., encodes) a set of k information bits (e.g., corresponding to a TB) for transmission to the receiving device, e.g., as described with reference to FIGS. 2 and 3.

The processing flow 600 illustrates an example approximation method by which the transmitting device may approximate one or more values of a logarithm of a cumulative sequence quantity log N_{c}(n, E), where the approximation is denoted by log \hat{N}_{c}(n, E). As described with reference to FIG. 3, the transmitting device may encode the k information bits to obtain a symbol sequence based on the approximation. In FIG. 6, the transmitting device may determine log \hat{N}_{c}(n, E) using an approximation formula that corresponds to an approximation region of a feasible region [symbol] ₘ.

The approximation formulas described with reference to FIGS. 4 and 5, such as those indicated by Equations 13 and 14, may enable the transmitting device to approximate log N_{c}(n, E) with relatively high accuracy, e.g., such that a value of log \hat{N}_{c}(n, E) is relatively close to an actual value of log N_{c}(n, E). In some scenarios, however, such levels of accuracy may be superfluous, and the transmitting device may achieve the same or similar encoding results with a less accurate approximation. For example, the transmitting device may utilize fewer approximation terms to determine log \hat{N}_{c}(n, E), which may reduce computational and processing power utilized during the encoding. That is, the transmitting device may adjust the approximation formula based on accuracy and computational tradeoffs by selecting approximation terms or using different combinations of approximation terms.

The transmitting device may, for example, select approximation terms for an approximation formula based on one or more values of n and E. In some cases, one or more approximation terms may correspond to approximation regions of the feasible region, and the transmitting device may select approximation terms based on an approximation region associated with the one or more values of n and E. For example, a first approximation region may be associated with a first approximation formula that includes a greater quantity of approximation terms than a second approximation formula associated with a second approximation region. Thus, for some values of n and E, the transmitting device may utilize the first approximation formula, while for other values of n and E, the transmitting device may utilize the second approximation formula. The second approximation formula may be less accurate than the first approximation formula, but may utilize less processing power at the transmitting device.

For a first symbol alphabet [symbol] ₘ and an associated feasible region [symbol] ₘ (e.g., defined by Equation 10), symbols of [symbol] ₘ may each have a symbol energy E(aᵢ), where E(aₘ) is a maximum symbol energy associated with [symbol] ₘ. At 605, the transmitting device may partition the feasible region into a quantity Kₘ of approximating regions. The transmitting device may determine a first sequence length n and a first sequence energy E that is less than or equal to an energy threshold Ē, such that (n, E)∈ [symbol] ₘ. At 610, the transmitting device may determine a value of a normalized energy ω (e.g., ω=E/n) based on the first sequence length, the first sequence energy, and the first symbol alphabet [symbol] ₘ.

Each approximating region of the feasible region may correspond to a respective approximation formula, where each approximation formula includes one or more approximation terms. Further, each approximating region may be associated with (e.g., correspond to) a value of the first sequence length and the first sequence energy. For example, the transmitting device may partition the feasible region into the approximating regions such that the boundaries of each approximating region are based on the first sequence length and the first sequence energy. In some examples, the transmitting device may partition the feasible region into the approximating regions based on the value of the normalized energy ω. Table 1 illustrates an example in which the transmitting device partitions the feasible region into Kₘ=6 approximating regions.

TABLE 1

| Approximating | |
|---|---|
| Region | Values of n, E, and ω |
| [symbol] ₁ | {(n, [symbol] ) ϵ [symbol] ₘ \| [symbol] ≤ ω₁n} |
| [symbol] ₂ | {(n, [symbol] ) ϵ [symbol] ₘ \| n_{mid} ≤ n, ω₁n < [symbol] ≤ ω₂n} |
| [symbol] ₃ | {(n, [symbol] ) ϵ Rₘ \| n < n_{mid}, ω₁n < [symbol] ≤ ω₅n} ∪ {(n, [symbol] ) |
| | ϵ [symbol] ₘ \| n_{mid} ≤ n, ω₂n < [symbol] ≤ ω₃n} |
| [symbol] ₄ | {(n, [symbol] ) ϵ Rₘ \| n_{mid} ≤ n, ω₃n < [symbol] ≤ ω₄n} |
| [symbol] ₅ | {(n, [symbol] ) ϵ Rₘ \| n_{mid} ≤ n, ω₄n < [symbol] ≤ ω₅n} |
| [symbol] ₆ | {(n, [symbol] ) ϵ Rₘ \| ω₅n < [symbol] } |

In the example of Table 1, the first approximating region [symbol] ₁ may be associated with relatively small values of ω, while the second approximating region [symbol] ₂ may be associated with intermediate values of ω. The third approximating region [symbol] ₃ may be defined as a near-ω^{u} region and may be associated with values of ω that are relatively close to an average value of ω^{u} (e.g., a uniform energy as defined by Equation 12) associated with the symbol alphabet [symbol] ₘ. The fourth approximating region [symbol] ₄ may be defined as a post-ω^{u} region and may be associated with values of ω that are greater than the average value of ω^{u}. [symbol] ₅, the fifth approximating region, may be associated with relatively large values of ω, while the sixth approximating region, [symbol] ₆, may be associated with constant values of the saturated entropy function evaluated at ω (e.g., H^{sat}(ω) may be constant and may be equal to log m).

At 615, the transmitting device may determine the approximating region [symbol] that corresponds to the first sequence length n and the first sequence energy E based on the value of the normalized energy ω. At 620, the transmitting device may determine the approximation formula corresponding to the approximating region [symbol] , and at 625, the transmitting device may approximate log N_{c}(n, E) (e.g., may calculate log \hat{N}_{c}(n, E)) using the approximation formula.

For example, if (n, E)∈{(n, [symbol] )∈ [symbol] ₘ| [symbol] ≤ω₁n}), the transmitting device may determine that (n, E) belongs to the small-ω approximating region [symbol] ₁. Here, the transmitting device may approximate the corresponding log N_{c}(n, E) in accordance with Equation 15.

$$log {\hat{N}}_{c} ( n , E ) = {nH}^{sat} ( ω ) + {G}_{lg} ( ω ) log n + {G}_{0} ( ω ) + \frac{1}{n} {G}_{1} ( ω ) + c ( E ) \qquad ( 15 )$$

If (n, E)∈{(n, [symbol] )∈ [symbol] ₘ|n_{mid}≤n, ω₁n< [symbol] ≤ω₂n}, the transmitting device may determine that (n, E) belongs to the intermediate-ω approximating region [symbol] ₂, and may approximate the corresponding log N_{c}(n, E) in accordance with Equation 16.

$$log {\hat{N}}_{c} ( n , E ) = {nH}^{sat} ( ω ) + {G}_{lg} ( ω ) log n + {G}_{0} ( ω ) + \frac{1}{n} {G}_{1} ( ω ) \qquad ( 16 )$$

If (n, E) belongs to the near-ω^{u} region [symbol] ₃ and E≤ω^{u}n—that is, if either (n, E)∈{(n, [symbol] )∈ [symbol] ₘ|n<n_{mid}, ω₁n< [symbol] ≤ω₅n} and E≤ω^{u}n are true, or if (n, E)∈{(n, [symbol] )∈ [symbol] ₘ|n_{mid}≤n, ω₂n< [symbol] ≤ω₃n} and E≤ω^{u}n are true—then the corresponding log N_{c}(n, E) is approximated in accordance with Equation 17.

$$log {\hat{N}}_{c} ( n , E ) = {nH}^{sat} ( ω ) + {G}_{0} ( ω ) + {G}_{0}^{s} ( v ) + \frac{1}{\sqrt{n}} {G}_{\frac{1}{2}}^{s} ( v ) + \frac{1}{n} {G}_{1} ( ω ) + \frac{1}{n} {G}_{1}^{s} ( v ) \qquad ( 17 )$$

If (n, E) belongs to the the near-ω^{u} region [symbol] ₃ and E>ω^{u}n (e.g., if both (n, E)∈{(n, [symbol] )∈ [symbol] ₘ|n_{mid}≤n, ω₃n< [symbol] ≤ω₄n} and E>ω^{u}n are true), then the corresponding log N_{c}(n, E) is approximated in accordance with Equation 18.

$$log {\hat{N}}_{c} ( n , E ) = {nH}^{sat} ( ω ) + {G}_{0}^{s} ( v ) + \frac{1}{\sqrt{n}} {G}_{\frac{1}{2}}^{s} ( v ) + \frac{1}{n} {G}_{1}^{s} ( v ) \qquad ( 18 )$$

If (n, E) belongs to the post-ω^{u} approximating region [symbol] ₄ (e.g., if (n, E)∈{(n, [symbol] )∈ [symbol] ₘ|n_{mid}≤n, ω₃n< [symbol] ≤ω₄n}), then the corresponding log N(n, E) is approximated in accordance with Equation 19.

$$log {\hat{N}}_{c} ( n , E ) = {nH}^{sat} ( ω ) + {G}_{0}^{s} ( v ) + \frac{1}{\sqrt{n}} {G}_{\frac{1}{2}}^{s} ( v ) \qquad ( 19 )$$

If the transmitting device determines that (n, E)∈{(n, [symbol] )∈ [symbol] ₘ|n_{mid}≤n, ω₄n< [symbol] ≤ω₅n} such that (n, E) belongs to the large-ω approximating region [symbol] ₅, the transmitting device may approximate the corresponding log N_{c}(n, E) in accordance with Equation 20.

$$log {\hat{N}}_{c} ( n , E ) = {nH}^{sat} ( ω ) + {G}_{0}^{s} ( v ) \qquad ( 20 )$$

If (n, E)∈{(n, [symbol] )∈ [symbol] ₘ/ω₅n< [symbol] }, the transmitting device may determine that (n, E) belongs to the constant-ω approximating region [symbol] ₆, and may approximate the corresponding log N_{c}(n, E) in accordance with Equation 21.

$$log {\hat{N}}_{c} ( n , E ) = n log m \qquad ( 21 )$$

The transmitting device may encode the information bits to the symbol sequence based on the approximation determined using the approximation formula. As described with reference to FIGS. 2 and 3, the symbol sequence may have a second sequence length n̅ and a second sequence energy that is less than or equal to an energy threshold Ē, and each symbol within the symbol sequence may belong to a second symbol alphabet [symbol] _{m̅} of size m̅. The transmitting device may transmit a message including the symbol sequence to the receiving device.

In some cases, the first sequence length n, the first sequence energy E, and the first symbol alphabet [symbol] ₘ may be related to the second sequence length n̅, the second energy threshold Ē, and the second symbol alphabet [symbol] _{m̅}. For example, the first symbol alphabet [symbol] ₘ may be a subset of, or may be the same as, the second symbol alphabet [symbol] _{m̅}, and m may be less than or equal to m̅. Additionally, the first sequence length n may be less than or equal to the second sequence length n̅, and the first sequence energy E may be less than or equal to the energy threshold Ē.

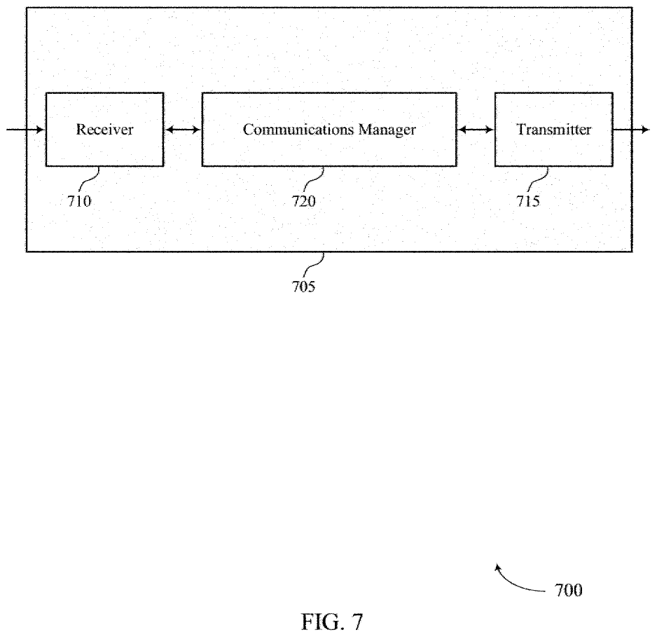

FIG. 7 illustrates a block diagram 700 of a device 705 that supports approximation in PCS in accordance with one or more aspects of the present disclosure. The device 705 may be an example of aspects of a UE 115 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to approximation in PCS). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to approximation in PCS). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of approximation in PCS as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 may be configured as or otherwise support a means for obtaining a set of information bits for a shaping procedure. The communications manager 720 may be configured as or otherwise support a means for determining a normalized energy value for the shaping procedure based on a ratio between a first sequence length and a first sequence energy associated with the shaping procedure. The communications manager 720 may be configured as or otherwise support a means for determining a first approximation term for the shaping procedure based on a saturated entropy function of the normalized energy value and the first sequence length. The communications manager 720 may be configured as or otherwise support a means for determining a second approximation term for the shaping procedure based on the normalized energy value and a first symbol alphabet having a first alphabet size. The communications manager 720 may be configured as or otherwise support a means for determining, as part of the shaping procedure, an approximation of a logarithm of a cumulative sequence quantity associated with the first sequence length, the first sequence energy, and the first symbol alphabet, where the approximation is based on the first approximation term and the second approximation term. The communications manager 720 may be configured as or otherwise support a means for encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold. The communications manager 720 may be configured as or otherwise support a means for transmitting a message including the symbol sequence based on the encoding.

Additionally, or alternatively, the communications manager 720 may support wireless communications at a wireless device in accordance with examples as disclosed herein. For example, the communications manager 720 may be configured as or otherwise support a means for obtaining a set of information bits for a shaping procedure. The communications manager 720 may be configured as or otherwise support a means for determining an approximation region from a set of approximation regions for the shaping procedure based on a first sequence length and a first sequence energy associated with the shaping procedure. The communications manager 720 may be configured as or otherwise support a means for determining, as part of the shaping procedure, an approximation formula corresponding to the approximation region, the approximation formula including one or more approximation terms that are based on the first sequence length, the first sequence energy, and a first symbol alphabet having a first alphabet size. The communications manager 720 may be configured as or otherwise support a means for determining, as part of the shaping procedure and using the approximation formula, an approximation of a logarithm of a cumulative sequence quantity associated with the first sequence length, the first sequence energy, and the first symbol alphabet. The communications manager 720 may be configured as or otherwise support a means for encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold. The communications manager 720 may be configured as or otherwise support a means for transmitting a message including at least the symbol sequence based on the encoding.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for a transmitting device, such as a network entity 105 or a UE 115, to approximate a logarithm of a cumulative sequence quantity as part of a shaping sequence to obtain a bit sequence with a non-uniform probability distribution prior to constellation mapping, which may cause reduced processing, reduced power consumption, more efficient utilization of communication resources, and the like.

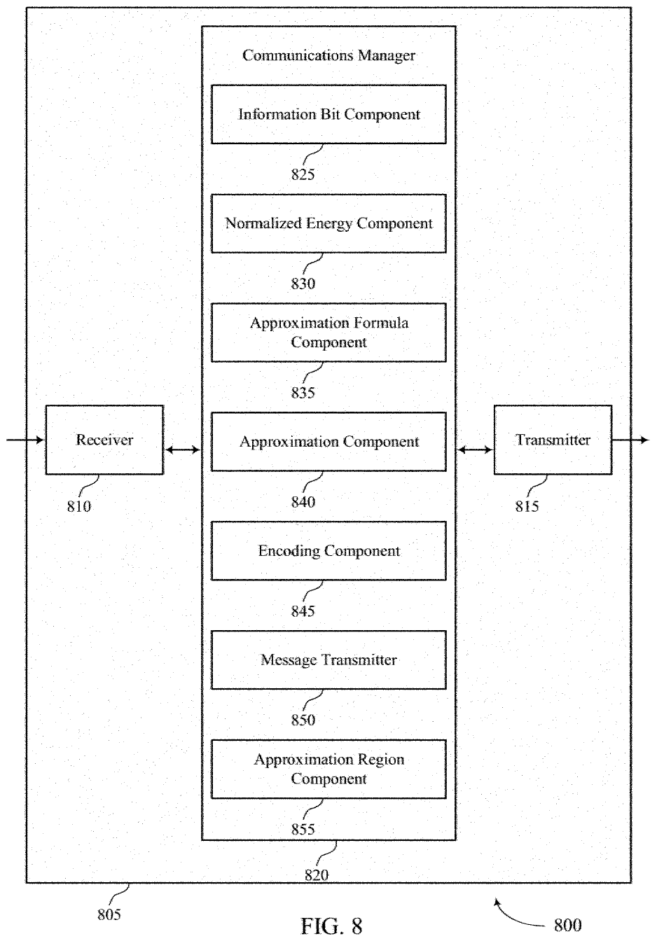

FIG. 8 illustrates a block diagram 800 of a device 805 that supports approximation in PCS in accordance with one or more aspects of the present disclosure. The device 805 may be an example of aspects of a device 705, a UE 115, or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to approximation in PCS). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to approximation in PCS). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of approximation in PCS as described herein. For example, the communications manager 820 may include an information bit component 825, a normalized energy component 830, an approximation formula component 835, an approximation component 840, an encoding component 845, a message transmitter 850, an approximation region component 855, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The information bit component 825 may be configured as or otherwise support a means for obtaining a set of information bits for a shaping procedure. The normalized energy component 830 may be configured as or otherwise support a means for determining a normalized energy value for the shaping procedure based on a ratio between a first sequence length and a first sequence energy associated with the shaping procedure. The approximation formula component 835 may be configured as or otherwise support a means for determining a first approximation term for the shaping procedure based on a saturated entropy function of the normalized energy value and the first sequence length. The approximation formula component 835 may be configured as or otherwise support a means for determining a second approximation term for the shaping procedure based on the normalized energy value and a first symbol alphabet having a first alphabet size. The approximation component 840 may be configured as or otherwise support a means for determining, as part of the shaping procedure, an approximation of a logarithm of a cumulative sequence quantity associated with the first sequence length, the first sequence energy, and the first symbol alphabet, where the approximation is based on the first approximation term and the second approximation term. The encoding component 845 may be configured as or otherwise support a means for encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold. The message transmitter 850 may be configured as or otherwise support a means for transmitting a message including the symbol sequence based on the encoding.

Additionally, or alternatively, the communications manager 820 may support wireless communications at a wireless device in accordance with examples as disclosed herein. The information bit component 825 may be configured as or otherwise support a means for obtaining a set of information bits for a shaping procedure. The approximation region component 855 may be configured as or otherwise support a means for determining an approximation region from a set of approximation regions for the shaping procedure based on a first sequence length and a first sequence energy associated with the shaping procedure. The approximation formula component 835 may be configured as or otherwise support a means for determining, as part of the shaping procedure, an approximation formula corresponding to the approximation region, the approximation formula including one or more approximation terms that are based on the first sequence length, the first sequence energy, and a first symbol alphabet having a first alphabet size. The approximation component 840 may be configured as or otherwise support a means for determining, as part of the shaping procedure and using the approximation formula, an approximation of a logarithm of a cumulative sequence quantity associated with the first sequence length, the first sequence energy, and the first symbol alphabet. The encoding component 845 may be configured as or otherwise support a means for encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold. The message transmitter 850 may be configured as or otherwise support a means for transmitting a message including at least the symbol sequence based on the encoding.

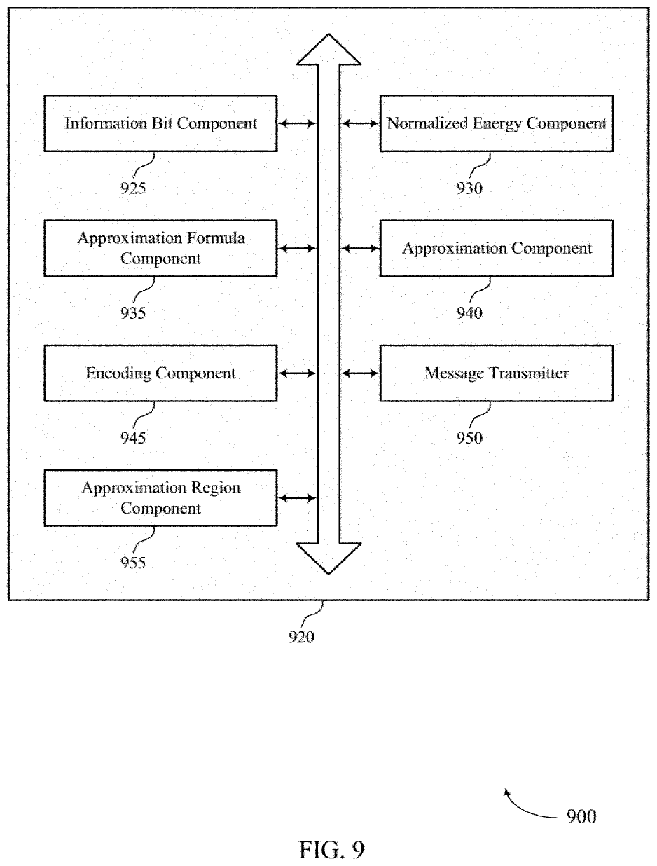

FIG. 9 illustrates a block diagram 900 of a communications manager 920 that supports approximation in PCS in accordance with one or more aspects of the present disclosure. The communications manager 920 may be an example of aspects of a communications manager 720, a communications manager 820, or both, as described herein. The communications manager 920, or various components thereof, may be an example of means for performing various aspects of approximation in PCS as described herein. For example, the communications manager 920 may include an information bit component 925, a normalized energy component 930, an approximation formula component 935, an approximation component 940, an encoding component 945, a message transmitter 950, an approximation region component 955, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communications in accordance with examples as disclosed herein. The information bit component 925 may be configured as or otherwise support a means for obtaining a set of information bits for a shaping procedure. The normalized energy component 930 may be configured as or otherwise support a means for determining a normalized energy value for the shaping procedure based on a ratio between a first sequence length and a first sequence energy associated with the shaping procedure. The approximation formula component 935 may be configured as or otherwise support a means for determining a first approximation term for the shaping procedure based on a saturated entropy function of the normalized energy value and the first sequence length. In some examples, the approximation formula component 935 may be configured as or otherwise support a means for determining a second approximation term for the shaping procedure based on the normalized energy value and a first symbol alphabet having a first alphabet size. The approximation component 940 may be configured as or otherwise support a means for determining, as part of the shaping procedure, an approximation of a logarithm of a cumulative sequence quantity associated with the first sequence length, the first sequence energy, and the first symbol alphabet, where the approximation is based on the first approximation term and the second approximation term. The encoding component 945 may be configured as or otherwise support a means for encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold. The message transmitter 950 may be configured as or otherwise support a means for transmitting a message including the symbol sequence based on the encoding.

In some examples, to support determining the approximation of the logarithm of the cumulative sequence quantity, the approximation component 940 may be configured as or otherwise support a means for calculating the approximation of the logarithm of the cumulative sequence quantity according to an approximation formula including a summation of at least the first approximation term and the second approximation term.

In some examples, the approximation formula component 935 may be configured as or otherwise support a means for determining one or more additional approximation terms, where the approximation of the logarithm of the cumulative sequence quantity is calculated based on the one or more additional approximation terms.

In some examples, the approximation formula is based on the first alphabet size. In some examples, each approximation term of the approximation formula is scaled by a respective factor of the first sequence length.

In some examples, the approximation formula component 935 may be configured as or otherwise support a means for determining a third approximation term for the shaping procedure based on a centralized and scaled energy value and the first sequence length. In some examples, the approximation formula component 935 may be configured as or otherwise support a means for determining a fourth approximation term for the shaping procedure based on the centralized and scaled energy value and the first sequence length, where the approximation of the logarithm of the cumulative sequence quantity is determined based on a summation of the first approximation term, the second approximation term, the third approximation term, and the fourth approximation term.

In some examples, the approximation formula component 935 may be configured as or otherwise support a means for calculating the centralized and scaled energy value based on a product of a square root of the first sequence length and a difference between the normalized energy value and an average energy value associated with the first symbol alphabet.

In some examples, the approximation formula component 935 may be configured as or otherwise support a means for determining a third approximation term for the shaping procedure based on the normalized energy value and the first sequence length. In some examples, the approximation formula component 935 may be configured as or otherwise support a means for determining a fourth approximation term for the shaping procedure based on the normalized energy value and the first sequence length, where the approximation of the logarithm of the cumulative sequence quantity is determined based on a summation of the first approximation term, the second approximation term, the third approximation term, and the fourth approximation term.

In some examples, to support determining the first approximation term, the approximation formula component 935 may be configured as or otherwise support a means for calculating a smooth function over an interval that is associated with a threshold symbol energy of the first symbol alphabet. In some examples, to support determining the second approximation term, the approximation formula component 935 may be configured as or otherwise support a means for calculating a piecewise smooth function over an interval that is associated with a threshold symbol energy of the first symbol alphabet.

In some examples, the first sequence length and the first sequence energy correspond to a feasible region associated with the first symbol alphabet.

In some examples, the first symbol alphabet is a subset of the second symbol alphabet. In some examples, the first sequence length is less than or equal to the second sequence length. In some examples, the first sequence energy is less than or equal to the energy threshold. In some examples, the first symbol alphabet is the same as the second symbol alphabet.

In some examples, the saturated entropy function is based on the first symbol alphabet. In some examples, the first approximation term is a product of the first sequence length and a value of the saturated entropy function evaluated at the normalized energy value.

In some examples, the logarithm of the cumulative sequence quantity includes a logarithm of a total quantity of symbol sequences over the first symbol alphabet having the first alphabet size. In some examples, each symbol sequence of the total quantity of symbol sequences is associated with the first sequence length. In some examples, each symbol sequence of the total quantity of symbol sequences is associated with a sequence energy that is less than or equal to the first sequence energy.

Additionally, or alternatively, the communications manager 920 may support wireless communications at a wireless device in accordance with examples as disclosed herein. In some examples, the information bit component 925 may be configured as or otherwise support a means for obtaining a set of information bits for a shaping procedure. The approximation region component 955 may be configured as or otherwise support a means for determining an approximation region from a set of approximation regions for the shaping procedure based on a first sequence length and a first sequence energy associated with the shaping procedure. In some examples, the approximation formula component 935 may be configured as or otherwise support a means for determining, as part of the shaping procedure, an approximation formula corresponding to the approximation region, the approximation formula including one or more approximation terms that are based on the first sequence length, the first sequence energy, and a first symbol alphabet having a first alphabet size. In some examples, the approximation component 940 may be configured as or otherwise support a means for determining, as part of the shaping procedure and using the approximation formula, an approximation of a logarithm of a cumulative sequence quantity associated with the first sequence length, the first sequence energy, and the first symbol alphabet. In some examples, the encoding component 945 may be configured as or otherwise support a means for encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold. In some examples, the message transmitter 950 may be configured as or otherwise support a means for transmitting a message including at least the symbol sequence based on the encoding.

In some examples, the normalized energy component 930 may be configured as or otherwise support a means for determining a normalized energy value for the shaping procedure based on a ratio between the first sequence length and the first sequence energy, where determining the approximation region is based on the normalized energy value.

In some examples, the approximation region component 955 may be configured as or otherwise support a means for partitioning a feasible region associated with the first symbol alphabet into the set of approximation regions, where each approximation region of the set of approximation regions corresponds to one or more approximation formulas of a set of approximation formulas.

In some examples, each approximation formula of the set of approximation formulas includes at least one approximation term that is based on a corresponding approximation region of the set of approximation regions. In some examples, the approximation formula component 935 may be configured as or otherwise support a means for selecting the one or more approximation terms for the approximation formula based on the approximation region. In some examples, each approximation term of the one or more approximation terms is scaled by a respective factor of the first sequence length.

In some examples, the first symbol alphabet is a subset of the second symbol alphabet. In some examples, the first sequence length is less than or equal to the second sequence length. In some examples, the first sequence energy is less than or equal to the energy threshold. In some examples, the first symbol alphabet is the same as the second symbol alphabet.

In some examples, the logarithm of the cumulative sequence quantity includes a logarithm of a total quantity of symbol sequences over the first symbol alphabet having the first alphabet size. In some examples, each symbol sequence of the total quantity of symbol sequences is associated with the first sequence length. In some examples, each symbol sequence of the total quantity of symbol sequences is associated with a sequence energy that is less than or equal to the first sequence energy.

In some examples, to support determining the approximation of the logarithm of the cumulative sequence quantity, the normalized energy component 930 may be configured as or otherwise support a means for determining a normalized energy value for the shaping procedure based on a ratio between the first sequence length and the first sequence energy. In some examples, to support determining the approximation of the logarithm of the cumulative sequence quantity, the approximation formula component 935 may be configured as or otherwise support a means for determining a first approximation term for the approximation formula based on a saturated entropy function of the normalized energy value and the first sequence length. In some examples, to support determining the approximation of the logarithm of the cumulative sequence quantity, the approximation formula component 935 may be configured as or otherwise support a means for determining a second approximation term for the approximation formula based on the first symbol alphabet and the normalized energy value, where the approximation of the logarithm of the cumulative sequence quantity is determined based on a summation of the first approximation term and the second approximation term.

In some examples, the approximation formula component 935 may be configured as or otherwise support a means for determining a third approximation term for the approximation formula based on a centralized and scaled energy value and the first sequence length. In some examples, the approximation formula component 935 may be configured as or otherwise support a means for determining a fourth approximation term for the approximation formula based on the centralized and scaled energy value and the first sequence length, where the approximation of the logarithm of the cumulative sequence quantity is determined based on a summation of the first approximation term, the second approximation term, the third approximation term, and the fourth approximation term.

In some examples, the approximation formula component 935 may be configured as or otherwise support a means for calculating the centralized and scaled energy value based on a product of a square root of the first sequence length and a difference between the normalized energy value and an average energy value associated with the first symbol alphabet.

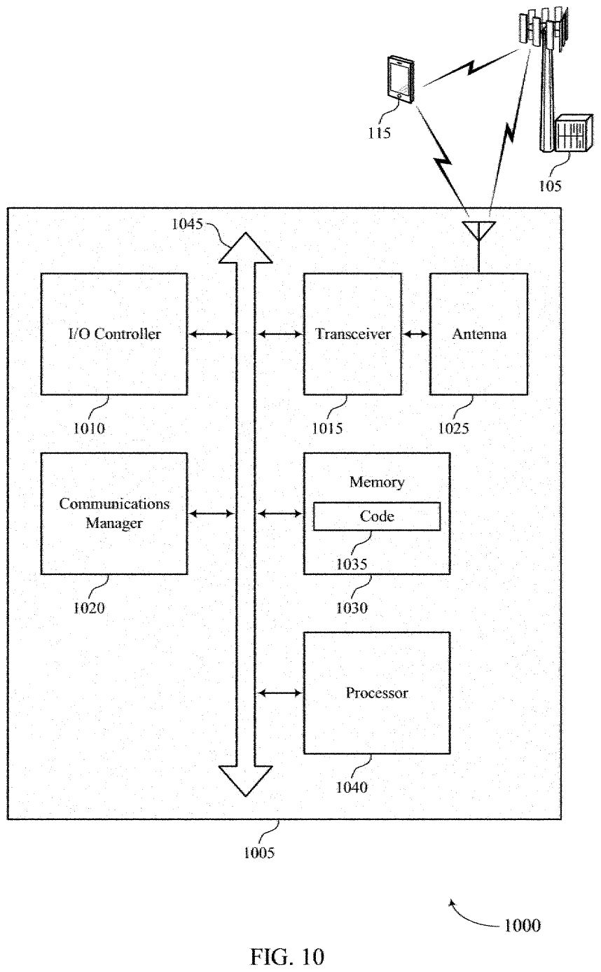

FIG. 10 illustrates a diagram of a system 1000 including a device 1005 that supports approximation in PCS in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting approximation in PCS). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications in accordance with examples as disclosed herein. For example, the communications manager 1020 may be configured as or otherwise support a means for obtaining a set of information bits for a shaping procedure. The communications manager 1020 may be configured as or otherwise support a means for determining a normalized energy value for the shaping procedure based on a ratio between a first sequence length and a first sequence energy associated with the shaping procedure. The communications manager 1020 may be configured as or otherwise support a means for determining a first approximation term for the shaping procedure based on a saturated entropy function of the normalized energy value and the first sequence length. The communications manager 1020 may be configured as or otherwise support a means for determining a second approximation term for the shaping procedure based on the normalized energy value and a first symbol alphabet having a first alphabet size. The communications manager 1020 may be configured as or otherwise support a means for determining, as part of the shaping procedure, an approximation of a logarithm of a cumulative sequence quantity associated with the first sequence length, the first sequence energy, and the first symbol alphabet, where the approximation is based on the first approximation term and the second approximation term. The communications manager 1020 may be configured as or otherwise support a means for encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold. The communications manager 1020 may be configured as or otherwise support a means for transmitting a message including the symbol sequence based on the encoding.

Additionally, or alternatively, the communications manager 1020 may support wireless communications at a wireless device in accordance with examples as disclosed herein. For example, the communications manager 1020 may be configured as or otherwise support a means for obtaining a set of information bits for a shaping procedure. The communications manager 1020 may be configured as or otherwise support a means for determining an approximation region from a set of approximation regions for the shaping procedure based on a first sequence length and a first sequence energy associated with the shaping procedure. The communications manager 1020 may be configured as or otherwise support a means for determining, as part of the shaping procedure, an approximation formula corresponding to the approximation region, the approximation formula including one or more approximation terms that are based on the first sequence length, the first sequence energy, and a first symbol alphabet having a first alphabet size. The communications manager 1020 may be configured as or otherwise support a means for determining, as part of the shaping procedure and using the approximation formula, an approximation of a logarithm of a cumulative sequence quantity associated with the first sequence length, the first sequence energy, and the first symbol alphabet. The communications manager 1020 may be configured as or otherwise support a means for encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold. The communications manager 1020 may be configured as or otherwise support a means for transmitting a message including at least the symbol sequence based on the encoding.

By including or configuring the communications manager 1020 in accordance with examples as described herein, the device 1005 may support techniques for a transmitting device, such as a network entity 105 or a UE 115, to approximate a logarithm of a cumulative sequence quantity as part of a shaping sequence to obtain a bit sequence with a non-uniform probability distribution prior to constellation mapping, which may improve utilization of processing and storage capabilities of the device, reduce power consumption, and reduce latency.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of approximation in PCS as described herein, or the processor 1040 and the memory 1030 may be otherwise configured to perform or support such operations.

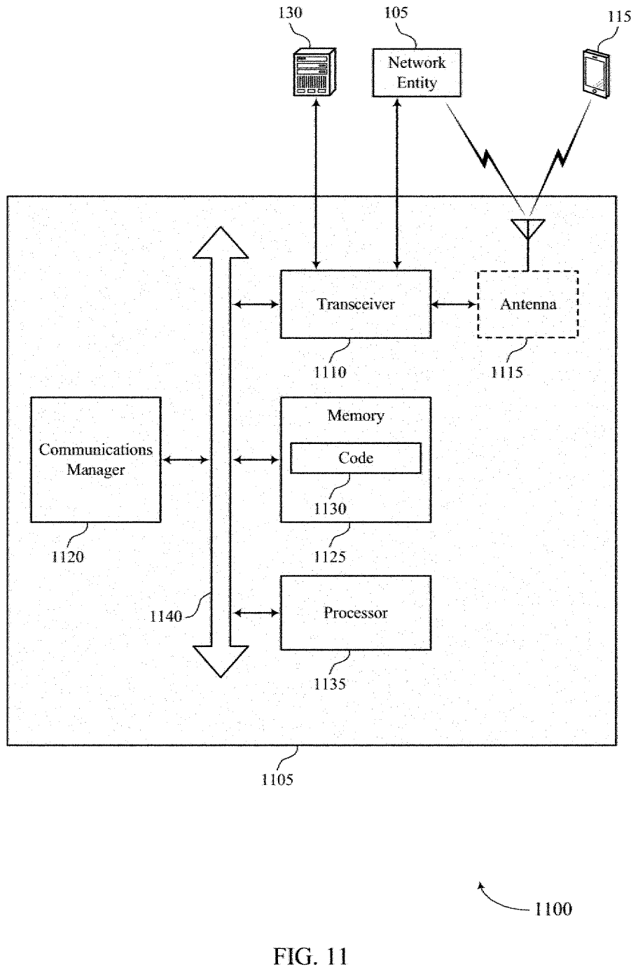

FIG. 11 illustrates a diagram of a system 1100 including a device 1105 that supports approximation in PCS in accordance with one or more aspects of the present disclosure. The device 1105 may be an example of or include the components of a device 705, a device 805, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting approximation in PCS). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 may be configured as or otherwise support a means for obtaining a set of information bits for a shaping procedure. The communications manager 1120 may be configured as or otherwise support a means for determining a normalized energy value for the shaping procedure based on a ratio between a first sequence length and a first sequence energy associated with the shaping procedure. The communications manager 1120 may be configured as or otherwise support a means for determining a first approximation term for the shaping procedure based on a saturated entropy function of the normalized energy value and the first sequence length. The communications manager 1120 may be configured as or otherwise support a means for determining a second approximation term for the shaping procedure based on the normalized energy value and a first symbol alphabet having a first alphabet size. The communications manager 1120 may be configured as or otherwise support a means for determining, as part of the shaping procedure, an approximation of a logarithm of a cumulative sequence quantity associated with the first sequence length, the first sequence energy, and the first symbol alphabet, where the approximation is based on the first approximation term and the second approximation term. The communications manager 1120 may be configured as or otherwise support a means for encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold. The communications manager 1120 may be configured as or otherwise support a means for transmitting a message including the symbol sequence based on the encoding.

Additionally, or alternatively, the communications manager 1120 may support wireless communications at a wireless device in accordance with examples as disclosed herein. For example, the communications manager 1120 may be configured as or otherwise support a means for obtaining a set of information bits for a shaping procedure. The communications manager 1120 may be configured as or otherwise support a means for determining an approximation region from a set of approximation regions for the shaping procedure based on a first sequence length and a first sequence energy associated with the shaping procedure. The communications manager 1120 may be configured as or otherwise support a means for determining, as part of the shaping procedure, an approximation formula corresponding to the approximation region, the approximation formula including one or more approximation terms that are based on the first sequence length, the first sequence energy, and a first symbol alphabet having a first alphabet size. The communications manager 1120 may be configured as or otherwise support a means for determining, as part of the shaping procedure and using the approximation formula, an approximation of a logarithm of a cumulative sequence quantity associated with the first sequence length, the first sequence energy, and the first symbol alphabet. The communications manager 1120 may be configured as or otherwise support a means for encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold. The communications manager 1120 may be configured as or otherwise support a means for transmitting a message including at least the symbol sequence based on the encoding.

By including or configuring the communications manager 1120 in accordance with examples as described herein, the device 1105 may support techniques for a transmitting device, such as a network entity 105 or a UE 115, to approximate a logarithm of a cumulative sequence quantity as part of a shaping sequence to obtain a bit sequence with a non-uniform probability distribution prior to constellation mapping, which may improve utilization of processing and storage capabilities of the device, reduce power consumption, and reduce latency.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of approximation in PCS as described herein, or the processor 1135 and the memory 1125 may be otherwise configured to perform or support such operations.

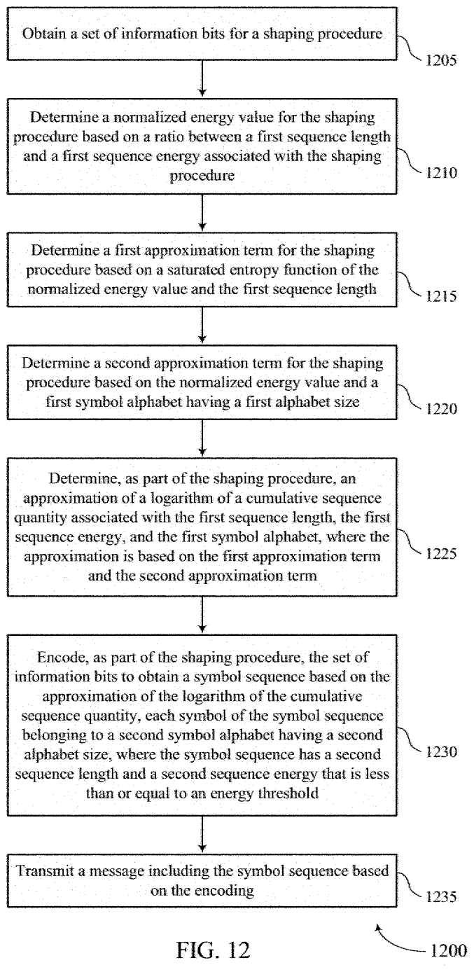

FIG. 12 illustrates a flowchart showing a method 1200 that supports approximation in PCS in accordance with one or more aspects of the present disclosure. The operations of the method 1200 may be implemented by a UE or a network entity or its components as described herein. For example, the operations of the method 1200 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include obtaining a set of information bits for a shaping procedure. The operations of 1205 may be performed in accordance with examples as disclosed herein. In some examples, aspects of the operations of 1205 may be performed by an information bit component 925 as described with reference to FIG. 9.

At 1210, the method may include determining a normalized energy value for the shaping procedure based on a ratio between a first sequence length and a first sequence energy associated with the shaping procedure. The operations of 1210 may be performed in accordance with examples as disclosed herein. In some examples, aspects of the operations of 1210 may be performed by a normalized energy component 930 as described with reference to FIG. 9.

At 1215, the method may include determining a first approximation term for the shaping procedure based on a saturated entropy function of the normalized energy value and the first sequence length. The operations of 1215 may be performed in accordance with examples as disclosed herein. In some examples, aspects of the operations of 1215 may be performed by an approximation formula component 935 as described with reference to FIG. 9.

At 1220, the method may include determining a second approximation term for the shaping procedure based on the normalized energy value and a first symbol alphabet having a first alphabet size. The operations of 1220 may be performed in accordance with examples as disclosed herein. In some examples, aspects of the operations of 1220 may be performed by an approximation formula component 935 as described with reference to FIG. 9.

At 1225, the method may include determining, as part of the shaping procedure, an approximation of a logarithm of a cumulative sequence quantity associated with the first sequence length, the first sequence energy, and the first symbol alphabet, where the approximation is based on the first approximation term and the second approximation term. The operations of 1225 may be performed in accordance with examples as disclosed herein. In some examples, aspects of the operations of 1225 may be performed by an approximation component 940 as described with reference to FIG. 9.

At 1230, the method may include encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold. The operations of 1230 may be performed in accordance with examples as disclosed herein. In some examples, aspects of the operations of 1230 may be performed by an encoding component 945 as described with reference to FIG. 9.

At 1235, the method may include transmitting a message including the symbol sequence based on the encoding. The operations of 1235 may be performed in accordance with examples as disclosed herein. In some examples, aspects of the operations of 1235 may be performed by a message transmitter 950 as described with reference to FIG. 9.

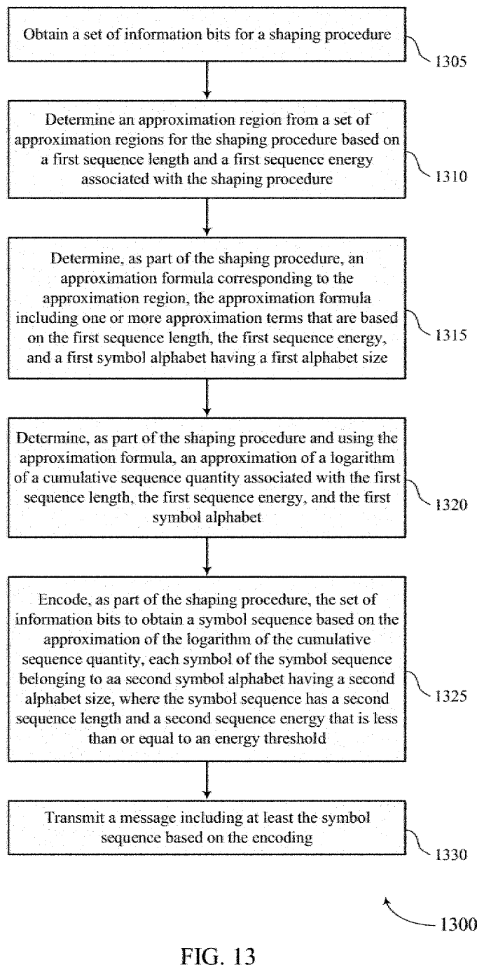

FIG. 13 illustrates a flowchart showing a method 1300 that supports approximation in PCS in accordance with one or more aspects of the present disclosure. The operations of the method 1300 may be implemented by a UE or a network entity or its components as described herein. For example, the operations of the method 1300 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include obtaining a set of information bits for a shaping procedure. The operations of 1305 may be performed in accordance with examples as disclosed herein. In some examples, aspects of the operations of 1305 may be performed by an information bit component 925 as described with reference to FIG. 9.

At 1310, the method may include determining an approximation region from a set of approximation regions for the shaping procedure based on a first sequence length and a first sequence energy associated with the shaping procedure. The operations of 1310 may be performed in accordance with examples as disclosed herein. In some examples, aspects of the operations of 1310 may be performed by an approximation region component 955 as described with reference to FIG. 9.

At 1315, the method may include determining, as part of the shaping procedure, an approximation formula corresponding to the approximation region, the approximation formula including one or more approximation terms that are based on the first sequence length, the first sequence energy, and a first symbol alphabet having a first alphabet size. The operations of 1315 may be performed in accordance with examples as disclosed herein. In some examples, aspects of the operations of 1315 may be performed by an approximation formula component 935 as described with reference to FIG. 9.

At 1320, the method may include determining, as part of the shaping procedure and using the approximation formula, an approximation of a logarithm of a cumulative sequence quantity associated with the first sequence length, the first sequence energy, and the first symbol alphabet. The operations of 1320 may be performed in accordance with examples as disclosed herein. In some examples, aspects of the operations of 1320 may be performed by an approximation component 940 as described with reference to FIG. 9.

At 1325, the method may include encoding, as part of the shaping procedure, the set of information bits to obtain a symbol sequence based on the approximation of the logarithm of the cumulative sequence quantity, each symbol of the symbol sequence belonging to a second symbol alphabet having a second alphabet size, where the symbol sequence has a second sequence length and a second sequence energy that is less than or equal to an energy threshold. The operations of 1325 may be performed in accordance with examples as disclosed herein. In some examples, aspects of the operations of 1325 may be performed by an encoding component 945 as described with reference to FIG. 9.

At 1330, the method may include transmitting a message including at least the symbol sequence based on the encoding. The operations of 1330 may be performed in accordance with examples as disclosed herein. In some examples, aspects of the operations of 1330 may be performed by a message transmitter 950 as described with reference to FIG. 9.

The following provides an overview of aspects of the present disclosure:
Aspect 1: A method for wireless communications, at a wireless device, comprising: obtaining a set of information bits for a shaping procedure; determining a normalized energy value for the shaping procedure based at least in part on a ratio between a first sequence length and a first sequence energy associated with the shaping procedure; determining a first approximation term for the shaping procedure based at least in part on a saturated entropy function of the normalized energy value and the first sequence length; determining a second approximation term for the shaping procedure based at least in part on the normalized energy value and a first symbol alphabet having a first alphabet size; determining, as part of the shaping procedure, an approximation of a logarithm of a cumulative sequence quantity associated with the first sequence length, the first sequence energy, and the first symbol alphabet, wherein the approximation is based at least in part on the first approximation term and the second approximation term; encoding, as part of the shaping procedure, the set of information bits to obtain a symbol sequence based at least in part on the approximation of the logarithm of the cumulative sequence quantity, each symbol of the symbol sequence belonging to a second symbol alphabet having a second alphabet size, wherein the symbol sequence has a second sequence length and a second sequence energy that is less than or equal to an energy threshold; and transmitting a message including the symbol sequence based at least in part on the encoding.
Aspect 2: The method of aspect 1, wherein determining the approximation of the logarithm of the cumulative sequence quantity comprises: calculating the approximation of the logarithm of the cumulative sequence quantity according to an approximation formula comprising a summation of at least the first approximation term and the second approximation term.
Aspect 3: The method of aspect 2, further comprising: determining one or more additional approximation terms, wherein the approximation of the logarithm of the cumulative sequence quantity is calculated based at least in part on the one or more additional approximation terms.
Aspect 4: The method of any of aspects 2 through 3, wherein the approximation formula is based at least in part on the first alphabet size.
Aspect 5: The method of any of aspects 2 through 4, wherein each approximation term of the approximation formula is scaled by a respective factor of the first sequence length.
Aspect 6: The method of any of aspects 1 through 5, further comprising: determining a third approximation term for the shaping procedure based at least in part on a centralized and scaled energy value and the first sequence length; and determining a fourth approximation term for the shaping procedure based at least in part on the centralized and scaled energy value and the first sequence length, wherein the approximation of the logarithm of the cumulative sequence quantity is determined based at least in part on a summation of the first approximation term, the second approximation term, the third approximation term, and the fourth approximation term.
Aspect 7: The method of aspect 6, further comprising: calculating the centralized and scaled energy value based at least in part on a product of a square root of the first sequence length and a difference between the normalized energy value and an average energy value associated with the first symbol alphabet.
Aspect 8: The method of any of aspects 1 through 5, further comprising: determining a third approximation term for the shaping procedure based at least in part on the normalized energy value and the first sequence length; and determining a fourth approximation term for the shaping procedure based at least in part on the normalized energy value and the first sequence length, wherein the approximation of the logarithm of the cumulative sequence quantity is determined based at least in part on a summation of the first approximation term, the second approximation term, the third approximation term, and the fourth approximation term.
Aspect 9: The method of any of aspects 1 through 8, wherein determining the first approximation term comprises: calculating a smooth function over an interval that is associated with a threshold symbol energy of the first symbol alphabet.
Aspect 10: The method of any of aspects 1 through 9, wherein determining the second approximation term comprises: calculating a piecewise smooth function over an interval that is associated with a threshold symbol energy of the first symbol alphabet.
Aspect 11: The method of any of aspects 1 through 10, wherein the first sequence length and the first sequence energy correspond to a feasible region associated with the first symbol alphabet.
Aspect 12: The method of any of aspects 1 through 11, wherein the first symbol alphabet is a subset of the second symbol alphabet; the first sequence length is less than or equal to the second sequence length; and the first sequence energy is less than or equal to the energy threshold.
Aspect 13: The method of aspect 12, wherein the first symbol alphabet is the same as the second symbol alphabet.
Aspect 14: The method of any of aspects 1 through 13, wherein the saturated entropy function is based at least in part on the first symbol alphabet.
Aspect 15: The method of any of aspects 1 through 14, wherein the first approximation term is a product of the first sequence length and a value of the saturated entropy function evaluated at the normalized energy value.
Aspect 16: The method of any of aspects 1 through 15, wherein the logarithm of the cumulative sequence quantity comprises a logarithm of a total quantity of symbol sequences over the first symbol alphabet having the first alphabet size; each symbol sequence of the total quantity of symbol sequences is associated with the first sequence length; and each symbol sequence of the total quantity of symbol sequences is associated with a sequence energy that is less than or equal to the first sequence energy.
Aspect 17: A method for wireless communications at a wireless device, comprising: obtaining a set of information bits for a shaping procedure; determining an approximation region from a set of approximation regions for the shaping procedure based at least in part on a first sequence length and a first sequence energy associated with the shaping procedure; determining, as part of the shaping procedure, an approximation formula corresponding to the approximation region, the approximation formula comprising one or more approximation terms that are based at least in part on the first sequence length, the first sequence energy, and a first symbol alphabet having a first alphabet size; determining, as part of the shaping procedure and using the approximation formula, an approximation of a logarithm of a cumulative sequence quantity associated with the first sequence length, the first sequence energy, and the first symbol alphabet; encoding, as part of the shaping procedure, the set of information bits to obtain a symbol sequence based at least in part on the approximation of the logarithm of the cumulative sequence quantity, each symbol of the symbol sequence belonging to aa second symbol alphabet having a second alphabet size, wherein the symbol sequence has a second sequence length and a second sequence energy that is less than or equal to an energy threshold; and transmitting a message including at least the symbol sequence based at least in part on the encoding.
Aspect 18: The method of aspect 17, further comprising: determining a normalized energy value for the shaping procedure based at least in part on a ratio between the first sequence length and the first sequence energy, wherein determining the approximation region is based at least in part on the normalized energy value.
Aspect 19: The method of any of aspects 17 through 18, further comprising: partitioning a feasible region associated with the first symbol alphabet into the set of approximation regions, wherein each approximation region of the set of approximation regions corresponds to one or more approximation formulas of a set of approximation formulas.
Aspect 20: The method of aspect 19, wherein each approximation formula of the set of approximation formulas includes at least one approximation term that is based at least in part on a corresponding approximation region of the set of approximation regions.
Aspect 21: The method of any of aspects 17 through 20, further comprising: selecting the one or more approximation terms for the approximation formula based at least in part on the approximation region.
Aspect 22: The method of any of aspects 17 through 21, wherein each approximation term of the one or more approximation terms is scaled by a respective factor of the first sequence length.
Aspect 23: The method of any of aspects 17 through 22, wherein the first symbol alphabet is a subset of the second symbol alphabet; the first sequence length is less than or equal to the second sequence length; and the first sequence energy is less than or equal to the energy threshold.
Aspect 24: The method of aspect 23, wherein the first symbol alphabet is the same as the second symbol alphabet.
Aspect 25: The method of any of aspects 17 through 24, wherein the logarithm of the cumulative sequence quantity comprises a logarithm of a total quantity of symbol sequences over the first symbol alphabet having the first alphabet size; each symbol sequence of the total quantity of symbol sequences is associated with the first sequence length; and each symbol sequence of the total quantity of symbol sequences is associated with a sequence energy that is less than or equal to the first sequence energy.
Aspect 26: The method of any of aspects 17 through 25, wherein determining the approximation of the logarithm of the cumulative sequence quantity further comprises: determining a normalized energy value for the shaping procedure based at least in part on a ratio between the first sequence length and the first sequence energy; determining a first approximation term for the approximation formula based at least in part on a saturated entropy function of the normalized energy value and the first sequence length; and determining a second approximation term for the approximation formula based at least in part on the first symbol alphabet and the normalized energy value, wherein the approximation of the logarithm of the cumulative sequence quantity is determined based at least in part on a summation of the first approximation term and the second approximation term.
Aspect 27: The method of aspect 26, further comprising: determining a third approximation term for the approximation formula based at least in part on a centralized and scaled energy value and the first sequence length; and determining a fourth approximation term for the approximation formula based at least in part on the centralized and scaled energy value and the first sequence length, wherein the approximation of the logarithm of the cumulative sequence quantity is determined based at least in part on a summation of the first approximation term, the second approximation term, the third approximation term, and the fourth approximation term.
Aspect 28: The method of aspect 27, further comprising: calculating the centralized and scaled energy value based at least in part on a product of a square root of the first sequence length and a difference between the normalized energy value and an average energy value associated with the first symbol alphabet.
Aspect 29: An apparatus for wireless communications, comprising a processor; memory coupled with the processor; and instructions stored in the memory and executable by the processor to cause the apparatus to perform a method of any of aspects 1 through 16.
Aspect 30: An apparatus for wireless communications, comprising at least one means for performing a method of any of aspects 1 through 16.
Aspect 31: A non-transitory computer-readable medium storing code for wireless communications, the code comprising instructions executable by a processor to perform a method of any of aspects 1 through 16.
Aspect 32: An apparatus for wireless communications at a wireless device, comprising a processor; memory coupled with the processor; and instructions stored in the memory and executable by the processor to cause the apparatus to perform a method of any of aspects 17 through 28.
Aspect 33: An apparatus for wireless communications at a wireless device, comprising at least one means for performing a method of any of aspects 17 through 28.
Aspect 34: A non-transitory computer-readable medium storing code for wireless communications at a wireless device, the code comprising instructions executable by a processor to perform a method of any of aspects 17 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications, comprising:
a processor one or more processors;
memory coupled with the one or more processors; and
instructions stored in the memory and executable by the one or more processors to cause the apparatus to:
obtain a set of information bits for a shaping procedure;
determine a normalized energy value for the shaping procedure based at least in part on a ratio between a first sequence length and a first sequence energy associated with the shaping procedure;
determine a first approximation term for the shaping procedure based at least in part on a saturated entropy function of the normalized energy value and the first sequence length;
determine a second approximation term for the shaping procedure based at least in part on the normalized energy value and a first symbol alphabet having a first alphabet size;
determine, as part of the shaping procedure, an approximation of a logarithm of a cumulative sequence quantity associated with the first sequence length, the first sequence energy, and the first symbol alphabet, wherein the approximation is based at least in part on the first approximation term and the second approximation term;
encode, as part of the shaping procedure, the set of information bits to obtain a symbol sequence based at least in part on the approximation of the logarithm of the cumulative sequence quantity, each symbol of the symbol sequence belonging to a second symbol alphabet having a second alphabet size, wherein the symbol sequence has a second sequence length and a second sequence energy that is less than or equal to an energy threshold; and
transmit a message including the symbol sequence based at least in part on the encoding.

2. The apparatus of claim 1, wherein the instructions to determine the approximation of the logarithm of the cumulative sequence quantity are executable by the processor to cause the apparatus to:
calculate the approximation of the logarithm of the cumulative sequence quantity according to an approximation formula comprising a summation of at least the first approximation term and the second approximation term.

3. The apparatus of claim 2, wherein the instructions are further executable by the one or more processors to cause the apparatus to:
determine one or more additional approximation terms, wherein the approximation of the logarithm of the cumulative sequence quantity is calculated based at least in part on the one or more additional approximation terms.

4. The apparatus of claim 2, wherein the approximation formula is based at least in part on the first alphabet size.

5. The apparatus of claim 2, wherein each approximation term of the approximation formula is scaled by a respective factor of the first sequence length.

6. The apparatus of claim 1, wherein the instructions are further executable by the one or more processors to cause the apparatus to:
determine a third approximation term for the shaping procedure based at least in part on a centralized and scaled energy value and the first sequence length; and
determine a fourth approximation term for the shaping procedure based at least in part on the centralized and scaled energy value and the first sequence length, wherein the approximation of the logarithm of the cumulative sequence quantity is determined based at least in part on a summation of the first approximation term, the second approximation term, the third approximation term, and the fourth approximation term.

7. The apparatus of claim 6, wherein the instructions are further executable by the one or more processors to cause the apparatus to:
calculate the centralized and scaled energy value based at least in part on a product of a square root of the first sequence length and a difference between the normalized energy value and an average energy value associated with the first symbol alphabet.

8. The apparatus of claim 1, wherein the instructions are further executable by the one or more processors to cause the apparatus to:
determine a third approximation term for the shaping procedure based at least in part on the normalized energy value and the first sequence length, and
determine a fourth approximation term for the shaping procedure based at least in part on the normalized energy value and the first sequence length, wherein the approximation of the logarithm of the cumulative sequence quantity is determined based at least in part on a summation of the first approximation term, the second approximation term, the third approximation term, and the fourth approximation term.

9-11. (canceled)

12. The apparatus of claim 1, wherein:
the first symbol alphabet is a subset of the second symbol alphabet;
the first sequence length is less than or equal to the second sequence length; and
the first sequence energy is less than or equal to the energy threshold.

13-15. (canceled)

16. The apparatus of claim 1, wherein:
the logarithm of the cumulative sequence quantity comprises a logarithm of a total quantity of symbol sequences over the first symbol alphabet having the first alphabet size;
each symbol sequence of the total quantity of symbol sequences is associated with the first sequence length; and
each symbol sequence of the total quantity of symbol sequences is associated with a sequence energy that is less than or equal to the first sequence energy.

17. An apparatus for wireless communications at a wireless device, comprising:
one or more processors,
memory coupled with the one or more processors; and
instructions stored in the memory and executable by the one or more processors to cause the apparatus to:
obtain a set of information bits for a shaping procedure;
determine an approximation region from a set of approximation regions for the shaping procedure based at least in part on a first sequence length and a first sequence energy associated with the shaping procedure;
determine, as part of the shaping procedure, an approximation formula corresponding to the approximation region, the approximation formula comprising one or more approximation terms that are based at least in part on the first sequence length, the first sequence energy, and a first symbol alphabet having a first alphabet size;
determine, as part of the shaping procedure and using the approximation formula, an approximation of a logarithm of a cumulative sequence quantity associated with the first sequence length, the first sequence energy, and the first symbol alphabet;
encode, as part of the shaping procedure, the set of information bits to obtain a symbol sequence based at least in part on the approximation of the logarithm of the cumulative sequence quantity, each symbol of the symbol sequence belonging to aa second symbol alphabet having a second alphabet size, wherein the symbol sequence has a second sequence length and a second sequence energy that is less than or equal to an energy threshold; and
transmit a message including at least the symbol sequence based at least in part on the encoding.

18. The apparatus of claim 17, wherein the instructions are further executable by the one or more processors to cause the apparatus to:
determine a normalized energy value for the shaping procedure based at least in part on a ratio between the first sequence length and the first sequence energy, wherein determining the approximation region is based at least in part on the normalized energy value.

19. The apparatus of claim 17, wherein the instructions are further executable by the one or more processors to cause the apparatus to:
partition a feasible region associated with the first symbol alphabet into the set of approximation regions, wherein each approximation region of the set of approximation regions corresponds to one or more approximation formulas of a set of approximation formulas.

20. The apparatus of claim 19, wherein each approximation formula of the set of approximation formulas includes at least one approximation term that is based at least in part on a corresponding approximation region of the set of approximation regions.

21. The apparatus of claim 17, wherein the instructions are further executable by the one or more processors to cause the apparatus to:
select the one or more approximation terms for the approximation formula based at least in part on the approximation region.

22. The apparatus of claim 17, wherein each approximation term of the one or more approximation terms is scaled by a respective factor of the first sequence length.

23. The apparatus of claim 17, wherein:
the first symbol alphabet is a subset of the second symbol alphabet;
the first sequence length is less than or equal to the second sequence length; and
the first sequence energy is less than or equal to the energy threshold.

24. (canceled)

25. The apparatus of claim 17, wherein:
the logarithm of the cumulative sequence quantity comprises a logarithm of a total quantity of symbol sequences over the first symbol alphabet having the first alphabet size;
each symbol sequence of the total quantity of symbol sequences is associated with the first sequence length; and
each symbol sequence of the total quantity of symbol sequences is associated with a sequence energy that is less than or equal to the first sequence energy.

26. The apparatus of claim 17, wherein the instructions to determine the approximation of the logarithm of the cumulative sequence quantity are further executable by the one or more processors to cause the apparatus to:
determine a normalized energy value for the shaping procedure based at least in part on a ratio between the first sequence length and the first sequence energy;
determine a first approximation term for the approximation formula based at least in part on a saturated entropy function of the normalized energy value and the first sequence length; and
determine a second approximation term for the approximation formula based at least in part on the first symbol alphabet and the normalized energy value, wherein the approximation of the logarithm of the cumulative sequence quantity is determined based at least in part on a summation of the first approximation term and the second approximation term.

27-28. (canceled)

29. A method for wireless communications, at a wireless device, comprising:
obtaining a set of information bits for a shaping procedure;
determining a normalized energy value for the shaping procedure based at least in part on a ratio between a first sequence length and a first sequence energy associated with the shaping procedure;
determining a first approximation term for the shaping procedure based at least in part on a saturated entropy function of the normalized energy value and the first sequence length;
determining a second approximation term for the shaping procedure based at least in part on the normalized energy value and a first symbol alphabet having a first alphabet size;
determining, as part of the shaping procedure, an approximation of a logarithm of a cumulative sequence quantity associated with the first sequence length, the first sequence energy, and the first symbol alphabet, wherein the approximation is based at least in part on the first approximation term and the second approximation term;
encoding, as part of the shaping procedure, the set of information bits to obtain a symbol sequence based at least in part on the approximation of the logarithm of the cumulative sequence quantity, each symbol of the symbol sequence belonging to a second symbol alphabet having a second alphabet size, wherein the symbol sequence has a second sequence length and a second sequence energy that is less than or equal to an energy threshold; and
transmitting a message including the symbol sequence based at least in part on the encoding.

30. (canceled)
